(19) United States
(12) Patent Application Publication
(10) Pub. No.: US 2024/0292950 A1
(43) Pub. Date: Sep. 5, 2024

(54) COUPLING A FURNITURE ACCESSORY TO A FURNITURE APPARATUS

(71) Applicant: PALLISER FURNITURE LTD., Winnipeg (CA)

(72) Inventors: Nelson TRAVASSOS, Winnipeg (CA); David MAIN, Winnipeg (CA)

(21) Appl. No.: 18/583,792

(22) Filed: Feb. 21, 2024

Related U.S. Application Data
(60) Provisional application No. 63/447,578, filed on Feb. 22, 2023.

(51) Int. Cl. A47B 97/00; H01R 13/02

(52) U.S. Cl. CPC A47B 97/00; H01R 13/025; A47B 2097/003; A47B 2220/0091; H01R 2201/00

(57) ABSTRACT

This disclosure relates generally to coupling a furniture accessory to a furniture apparatus. One embodiment provides a method of electrically coupling at least one electrical contact on a furniture accessory to at least one electrical contact on a furniture apparatus. The method may comprise positioning a portion of an elongate body, coupled to the furniture apparatus, in a space between at least two retaining bodies of a retainer coupled to the furniture accessory such that the at least two retaining bodies contact an exterior surface of the elongate body on at least the portion of the elongate body and retain at least the portion of the elongate body in the space. Positioning the portion of the elongate body in the space may comprise electrically coupling at least one electrical contact of the furniture accessory with at least one electrical contact of the furniture apparatus.

### RELATED APPLICATION

This application claims the benefit of and priority to U.S. provisional patent application No. 63/447,578 filed Feb. 22, 2023. The entire contents of U.S. provisional patent application No. 63/447,578 are incorporated by reference herein.

### FIELD

This disclosure relates generally to coupling a furniture accessory to a furniture apparatus.

### RELATED ART

Known methods of coupling a furniture accessory to a furniture apparatus may have some disadvantages.

### SUMMARY

According to at least one embodiment, a method of coupling a furniture accessory to a furniture apparatus comprises positioning a portion of an elongate body, coupled to the furniture accessory, in a space between at least two retaining bodies of a retainer coupled to the furniture apparatus such that the at least two retaining bodies contact an exterior surface of the elongate body on at least the portion of the elongate body and retain at least the portion of the elongate body in the space.

In some embodiments, positioning the portion of the elongate body in the space comprises rotating the elongate body and the furniture accessory towards the furniture apparatus.

In some embodiments, rotating the elongate body and the furniture accessory towards the furniture apparatus comprises rotating the elongate body and the furniture accessory around a portion of a second elongate body in a space between at least two retaining bodies of a second retainer coupled to the furniture apparatus.

In some embodiments, positioning the portion of the elongate body in the space comprises electrically coupling at least one electrical contact of the furniture accessory with at least one electrical contact of the furniture apparatus.

According to at least one embodiment, a method of electrically coupling at least one electrical contact on a furniture accessory to at least one electrical contact on a furniture apparatus, the method comprising positioning a portion of an elongate body, coupled to the furniture apparatus, in a space between at least two retaining bodies of a retainer coupled to the furniture accessory such that the at least two retaining bodies contact an exterior surface of the elongate body on at least the portion of the elongate body and retain at least the portion of the elongate body in the space. Positioning the portion of the elongate body in the space comprises electrically coupling at least one electrical contact of the furniture accessory with at least one electrical contact of the furniture apparatus.

In some embodiments, the at least one electrical contact of the furniture accessory comprises at least one electrical contact on the elongate body.

In some embodiments, the at least one electrical contact of the furniture apparatus comprises at least one electrical contact on the elongate body.

In some embodiments, the at least one electrical contact on the elongate body is on the exterior surface of the elongate body.

In some embodiments, the at least one electrical contact on the elongate body is flush with the exterior surface of the elongate body.

In some embodiments, the at least one electrical contact on the elongate body comprises at least one protrusion from the exterior surface of the elongate body.

In some embodiments, the at least one electrical contact on the elongate body comprises at least one electrical contact recessed behind the exterior surface of the elongate body.

In some embodiments, the at least one electrical contact on the elongate body is electrically coupled with at least one elongate-body electrical conductor, and at least a portion of the at least one elongate-body electrical conductor is enclosed in the elongate body.

In some embodiments, the at least one electrical contact of the furniture apparatus comprises at least one electrical contact on the retainer.

In some embodiments, the at least one electrical contact on the retainer is electrically coupled with at least one furniture-apparatus electrical conductor, and at least a portion of the at least one furniture-apparatus electrical conductor is enclosed in the furniture apparatus.

In some embodiments, the at least one electrical contact of the furniture accessory comprises at least one electrical contact on the retainer.

In some embodiments, the at least one electrical contact on the retainer faces into the space.

In some embodiments, the at least one electrical contact on the retainer is between the at least two retaining bodies.

In some embodiments, the at least one electrical contact on the retainer comprises at least one protrusion into the space.

In some embodiments, the at least one electrical contact on the retainer comprises at least one electrical contact recessed behind a surface defining at least a portion of the space.

In some embodiments, electrically coupling the at least one electrical contact of the furniture accessory with the at least one electrical contact of the furniture apparatus comprises electrically coupling at least one source of electric current of the furniture apparatus with at least one electrical load on the furniture accessory.

In some embodiments, at least a portion of the at least one source of electric current of the furniture apparatus is enclosed in the furniture apparatus.

In some embodiments, at least a portion of the at least one source of electric current of the furniture apparatus is on the furniture apparatus.

In some embodiments, at least a portion of the at least one source of electric current of the furniture apparatus is coupled to the furniture apparatus.

In some embodiments, the at least one source of electric current comprises at least one source of electrical control signals of the furniture apparatus.

In some embodiments, the at least one source of electric current comprises at least one source of electrical power of the furniture apparatus.

In some embodiments, electrically coupling the at least one electrical contact of the furniture accessory with the at least one electrical contact of the furniture apparatus comprises electrically coupling at least one source of electrical power of the furniture accessory with at least one electrical load on the furniture apparatus.

In some embodiments, the at least one source of electrical power of the furniture accessory comprises an electric battery.

In some embodiments, the at least one source of electrical power is configured to, at least: detect electrical coupling of the at least one source of electrical power to at least one authorized electrical load; and provide electrical power to the at least one authorized electrical load in response to detecting the at least one authorized electrical load.

In some embodiments, the at least one electrical load comprises an electric motor.

In some embodiments, the electric motor is operable to move at least a portion of the furniture accessory relative to the furniture apparatus.

In some embodiments, the at least one electrical load comprises an electric light source.

In some embodiments, at least a portion of the electric light source is enclosed in the elongate body and operable to transmit light through the exterior surface of the elongate body.

In some embodiments, the at least one electrical load comprises an electric battery charger.

In some embodiments, the electric battery charger is configured to charge a mobile device.

In some embodiments, the electric battery charger is configured to charge a device wirelessly.

In some embodiments: the elongate body is at least a portion of a rod; and the exterior surface of the elongate body is generally cylindrical.

In some embodiments, positioning the portion of the elongate body in the space comprises: causing at least one of the at least two retaining bodies to move resiliently to increase a separation distance between the at least two retaining bodies to allow the space to receive the portion of the elongate body; and after the space receives the portion of the elongate body, causing the at least one of the at least two retaining bodies to move resiliently to decrease the separation distance between the at least two retaining bodies to retain the portion of the elongate body in the space.

In some embodiments, the at least one electrical contact of the furniture accessory comprises at least one electrical contact on a first one of the at least two retaining bodies, and at least one electrical contact on a second one of the at least two retaining bodies.

In some embodiments, each of the at least one electrical contact on the first one of the at least two retaining bodies and the at least one electrical contact on the second one of the at least two retaining bodies comprises an electrically conductive strip.

In some embodiments, the first one of the at least two retaining bodies is at an offset angle to the second one of the at least two retaining bodies.

In some embodiments, the exterior surface of the elongate body comprises a first face and a second face, the first face at the offset angle to the second face.

In some embodiments, each of the first and second faces of the elongate body comprises an electrically conductive strip.

In some embodiments, positioning the portion of the elongate body in the space between the at least two retaining bodies of the retainer comprises causing the first one of the at least two retaining bodies to contact the first face of the elongate body, and causing the second one of the at least two retaining bodies to contact the second face of the elongate body.

In some embodiments, causing the first one of the at least two retaining bodies to contact the first face of the elongate body electrically couples the first one of the at least two retaining bodies to the first face of the elongate body, and causing the second one of the at least two retaining bodies to contact the second face of the elongate body electrically couples the second one of the at least two retaining bodies to the second face of the elongate body.

In some embodiments, the first one of the at least two retaining bodies is shorter than the second one of the at least two retaining bodies.

In some embodiments, the retainer comprises a French cleat.

In some embodiments, the elongate body comprises a mating cleat.

In some embodiments, the furniture apparatus comprises an upholstered bed.

In some embodiments, the furniture apparatus comprises a seating apparatus.

In some embodiments, the furniture apparatus is a seating apparatus consisting of at least one body configured to facilitate seating on the seating apparatus.

In some embodiments, the furniture apparatus is a seating apparatus consisting essentially of at least one body configured to facilitate seating on the seating apparatus.

In some embodiments, the seating apparatus is a chair.

In some embodiments, the furniture accessory is a second chair.

In some embodiments, the furniture accessory is a headrest.

In some embodiments, the furniture accessory is a table.

In some embodiments, the furniture accessory is a tray.

In some embodiments, positioning the portion of the elongate body in the space comprises mounting the furniture accessory on the furniture apparatus.

In some embodiments, positioning the portion of the elongate body in the space comprises coupling the furniture accessory directly to the furniture apparatus.

In some embodiments, the furniture apparatus is independent of any vehicle.

According to at least one embodiment, a furniture system comprises: a furniture accessory; an elongate body coupled to the furniture accessory; a furniture apparatus; and a retainer coupled to the furniture apparatus, the retainer comprising two retaining bodies and defining a space between at least the two retaining bodies; wherein a portion of the elongate body is positionable in the space such that, when the portion of the elongate body is positioned in the space, the at least two retaining bodies contact an exterior surface of the elongate body on at least the portion of the elongate body and retain at least the portion of the elongate body in the space.

In some embodiments, the system further comprises: a second elongate body coupled to the furniture accessory; and a second retainer coupled to the furniture apparatus, the second retainer comprising two retaining bodies and defining a space between at least the two retaining bodies of the second retainer; wherein when a portion of the second elongate body is in the space between the at least two retaining bodies of the second retainer, the elongate body and the furniture accessory are rotatable, around the portion of the second elongate body, such that the portion of the elongate body is positionable in the space of the retainer in response to rotation of the elongate body and the furniture accessory towards the furniture apparatus and around the portion of the second elongate body.

In some embodiments: the furniture accessory comprises at least one electrical contact; the furniture apparatus comprises at least one electrical contact; and the at least one electrical contact of the furniture accessory and the at least one electrical contact of the furniture apparatus are positioned such that the at least one electrical contact of the furniture accessory is electrically couplable with the at least one electrical contact of the furniture apparatus in response to positioning the portion of the elongate body in the space.

According to at least one embodiment, a furniture system comprises: a furniture accessory; a retainer coupled to the furniture accessory, the retainer comprising two retaining bodies and defining a space between at least the two retaining bodies; a furniture apparatus; and an elongate body coupled to the furniture apparatus. A portion of the elongate body is positionable in the space such that, when the portion of the elongate body is positioned in the space, the at least two retaining bodies contact an exterior surface of the elongate body on at least the portion of the elongate body and retain at least the portion of the elongate body in the space. The furniture accessory comprises at least one electrical contact. The furniture apparatus comprises at least one electrical contact. The at least one electrical contact of the furniture accessory and the at least one electrical contact of the furniture apparatus are positioned such that the at least one electrical contact of the furniture accessory is electrically couplable with the at least one electrical contact of the furniture apparatus in response to positioning the portion of the elongate body in the space.

In some embodiments, the at least one electrical contact of the furniture accessory comprises at least one electrical contact on the elongate body.

In some embodiments, the at least one electrical contact of the furniture apparatus comprises at least one electrical contact on the elongate body.

In some embodiments, the at least one electrical contact on the elongate body is on the exterior surface of the elongate body.

In some embodiments, the at least one electrical contact of the furniture apparatus comprises at least one electrical contact on the retainer.

In some embodiments, the at least one electrical contact on the retainer is electrically coupled with at least one furniture-apparatus electrical conductor, and at least a portion of the at least one furniture-apparatus electrical conductor is enclosed in the furniture apparatus.

In some embodiments, the at least one electrical contact of the furniture accessory comprises at least one electrical contact on the retainer.

In some embodiments, the at least one electrical contact on the retainer faces into the space.

According to at least one embodiment, a furniture system comprises: a furniture accessory; and an elongate body coupled to the furniture accessory, wherein at least one electrical contact of the furniture accessory is on an exterior surface of the elongate body.

According to at least one embodiment, a furniture system comprises: a furniture apparatus; and an elongate body coupled to the furniture accessory, wherein at least one electrical contact of the furniture apparatus is on an exterior surface of the elongate body.

According to at least one embodiment, a furniture system comprises: a furniture accessory; and a retainer coupled to the furniture accessory, the retainer comprising two retaining bodies and defining a space between at least the two retaining bodies, wherein at least one electrical contact of the furniture accessory is on the retainer and faces into the space.

According to at least one embodiment, a furniture system comprises: a furniture apparatus; and a retainer coupled to the furniture accessory, the retainer comprising two retaining bodies and defining a space between at least the two retaining bodies, wherein at least one electrical contact of the furniture apparatus is on the retainer and faces into the space.

In some embodiments, the at least one electrical contact on the elongate body is flush with the exterior surface of the elongate body.

In some embodiments, the at least one electrical contact on the elongate body comprises at least one protrusion from the exterior surface of the elongate body.

In some embodiments, the at least one electrical contact on the elongate body comprises at least one electrical contact recessed behind the exterior surface of the elongate body.

In some embodiments, the at least one electrical contact on the elongate body is electrically coupled with at least one elongate-body electrical conductor, and at least a portion of the at least one elongate-body electrical conductor is enclosed in the elongate body.

In some embodiments, the at least one electrical contact on the retainer is between the at least two retaining bodies.

In some embodiments, the at least one electrical contact on the retainer comprises at least one protrusion into the space.

In some embodiments, the at least one electrical contact on the retainer comprises at least one electrical contact recessed behind a surface defining at least a portion of the space.

In some embodiments: the furniture apparatus comprises at least one source of electric current; and the at least one source of electric current of the furniture apparatus is electrically coupled with the at least one electrical contact of the furniture apparatus.

In some embodiments, at least a portion of the at least one source of electric current of the furniture apparatus is enclosed in the furniture apparatus.

In some embodiments, at least a portion of the at least one source of electric current of the furniture apparatus is on the furniture apparatus.

In some embodiments, at least a portion of the at least one source of electric current of the furniture apparatus is coupled to the furniture apparatus.

In some embodiments, the at least one source of electric current comprises at least one source of electrical control signals of the furniture apparatus.

In some embodiments, the at least one source of electric current comprises at least one source of electrical power of the furniture apparatus.

In some embodiments: the furniture accessory comprises at least one source of electric power; and the at least one source of electric power of the furniture accessory is electrically coupled with the at least one electrical contact of the furniture accessory.

In some embodiments, the at least one source of electrical power of the furniture accessory comprises an electric battery.

In some embodiments, the at least one source of electrical power is configured to, at least: detect electrical coupling of the at least one source of electrical power to at least one authorized electrical load; and provide electrical power to the at least one authorized electrical load in response to detecting the at least one authorized electrical load.

In some embodiments, at least one electrical load is on the furniture apparatus.

In some embodiments, at least one electrical load is on the furniture accessory.

In some embodiments, the at least one electrical load comprises an electric motor.

In some embodiments, the electric motor is operable to move at least a portion of the furniture accessory relative to the furniture apparatus.

In some embodiments, the at least one electrical load comprises an electric light source.

In some embodiments, at least a portion of the electric light source is enclosed in the elongate body and operable to transmit light through the exterior surface of the elongate body.

In some embodiments, the at least one electrical load comprises an electric battery charger.

In some embodiments, the electric battery charger is configured to charge a mobile device.

In some embodiments, the electric battery charger is configured to charge a device wirelessly.

In some embodiments: the elongate body is at least a portion of a rod; and the exterior surface of the elongate body is generally cylindrical.

In some embodiments, at least one of the at least two retaining bodies is resiliently movable to increase a separation distance between the at least two retaining bodies.

In some embodiments, the at least two retaining bodies are positioned such that: the at least one of the at least two retaining bodies moves resiliently to increase the separation to allow the space to receive the portion of the elongate body; and after the space receives the portion of the elongate body, the at least one of the at least two retaining bodies moves resiliently to decrease the separation distance between the at least two retaining bodies to retain the portion of the elongate body in the space.

In some embodiments, the furniture apparatus comprises an upholstered bed.

In some embodiments, the furniture apparatus comprises a seating apparatus.

In some embodiments, the furniture apparatus is a seating apparatus consisting of at least one body configured to facilitate seating on the seating apparatus.

In some embodiments, the furniture apparatus is a seating apparatus consisting essentially of at least one body configured to facilitate seating on the seating apparatus.

In some embodiments, the furniture accessory is a second chair.

In some embodiments, the furniture accessory is a headrest.

In some embodiments, the furniture accessory is a table.

In some embodiments, the furniture accessory is a tray.

In some embodiments, the furniture apparatus is independent of any vehicle.

In some embodiments, the at least one electrical contact of the furniture accessory comprises at least one electrical contact on a first one of the at least two retaining bodies, and at least one electrical contact on a second one of the at least two retaining bodies.

In some embodiments, each of the at least one electrical contact on the first one of the at least two retaining bodies and the at least one electrical contact on the second one of the at least two retaining bodies comprises an electrically conductive strip.

In some embodiments, the first one of the at least two retaining bodies is at an offset angle to the second one of the at least two retaining bodies.

In some embodiments, the exterior surface of the elongate body comprises a first face and a second face, the first face at the offset angle to the second face.

In some embodiments, each of the first and second faces of the elongate body comprises an electrically conductive strip.

In some embodiments, the first one of the at least two retaining bodies contacts the first face of the elongate body, and the second one of the at least two retaining bodies contacts the second face of the elongate body.

In some embodiments, the first one of the at least two retaining bodies contacting the first face of the elongate body electrically couples the first one of the at least two retaining bodies to the first face of the elongate body, and the second one of the at least two retaining bodies contacting the second face of the elongate body electrically couples the second one of the at least two retaining bodies to the second face of the elongate body.

In some embodiments, the first one of the at least two retaining bodies is shorter than the second one of the at least two retaining bodies.

In some embodiments, the retainer comprises a French cleat.

In some embodiments, the elongate body comprises a mating cleat.

According to at least one embodiment, a furniture system comprises: an elongate body coupled to a surface, the elongate body and the surface defining a space; and a retainer. The retainer may be at least partially positionable within the space to couple the retainer to the elongate body such that when the retainer is at least partially positioned within the space the retainer has a first contact region contactingly engageable with the elongate body within the space and a second contact region engageable to at least partially prevent rotation of the retainer about the elongate body induced by a force in a direction that urges the retainer into the space. In some embodiments, the elongate body is coupled to a furniture apparatus.

In some embodiments, the retainer is coupled to a furniture accessory.

In some embodiments, the elongate body is coupled to a furniture accessory.

In some embodiments, the retainer is coupled to a furniture apparatus.

In some embodiments, the elongate body comprises at least one electrical contact and the retainer comprises at least one electrical contact. When the retainer is at least partially positioned in the space the at least one electrical contact of the retainer may be electrically coupled to the at least one electrical contact of the elongate body.

In some embodiments, the retainer has a length that is shorter than a length of the elongate body.

In some embodiments, the retainer comprises a French cleat.

In some embodiments, the elongate body comprises a mating cleat.

In some embodiments, the elongate body and the surface are removably coupled together.

In some embodiments, the elongate body and the surface are integrally coupled together.

According to at least one embodiment, a method of coupling a furniture accessory to a furniture apparatus comprises positioning at least partially a retainer within a space between an elongate body and a surface to which the elongate body is coupled. At least partially positioning the retainer within the space may contactingly engage a first contact region of the retainer with the elongate body within the space and may engage a second contact region of the retainer to at least partially prevent rotation of the retainer about the elongate body induced by a force in a direction that urges the retainer into the space.

In some embodiments, the elongate body is coupled to the furniture apparatus.

In some embodiments, the retainer is coupled to the furniture accessory.

In some embodiments, the elongate body is coupled to the furniture accessory.

In some embodiments, the retainer is coupled to the furniture apparatus.

In some embodiments, at least partially positioning the retainer in the space causes the the retainer to be electrically coupled to the elongate body.

In some embodiments, the retainer has a length that is shorter than a length of the elongate body.

In some embodiments, the retainer comprises a French cleat.

In some embodiments, the elongate body comprises a mating cleat.

In some embodiments, the elongate body and the surface are removably coupled together.

In some embodiments, the elongate body and the surface are integrally coupled together.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a perspective view of a furniture system according to one embodiment.

FIGS. 2 and 3 are perspective views of a backrest body of the furniture system of FIG. 1.

FIG. 4 is a perspective view of a retainer that may be coupled to the backrest body of FIGS. 2 and 3.

FIGS. 5 and 6 are perspective views of the retainer of FIG. 4 and of a headrest-support body of the furniture system of FIG. 1.

FIG. 7 is a perspective view of a headrest core and an electric headrest actuator of a headrest of the furniture system of FIG. 1.

FIGS. 8 to 10 are perspective views of a furniture system according to another embodiment.

FIGS. 11 and 12 are perspective views of a furniture system according to another embodiment.

FIGS. 13 and 14 are perspective views of a furniture system according to another embodiment.

FIGS. 15 and 16 are perspective views of a furniture system according to another embodiment.

FIGS. 17 and 18 are perspective views of a furniture system according to another embodiment.

FIGS. 19 and 20 are perspective views of a furniture system according to another embodiment.

FIGS. 21 and 22 are perspective views of a furniture system according to another embodiment.

FIGS. 23 and 24 are perspective views of a furniture system according to another embodiment.

FIG. 25 is a perspective view of a furniture system according to another embodiment.

FIGS. 26 to 30 are perspective views of a furniture system according to another embodiment.

### DETAILED DESCRIPTION

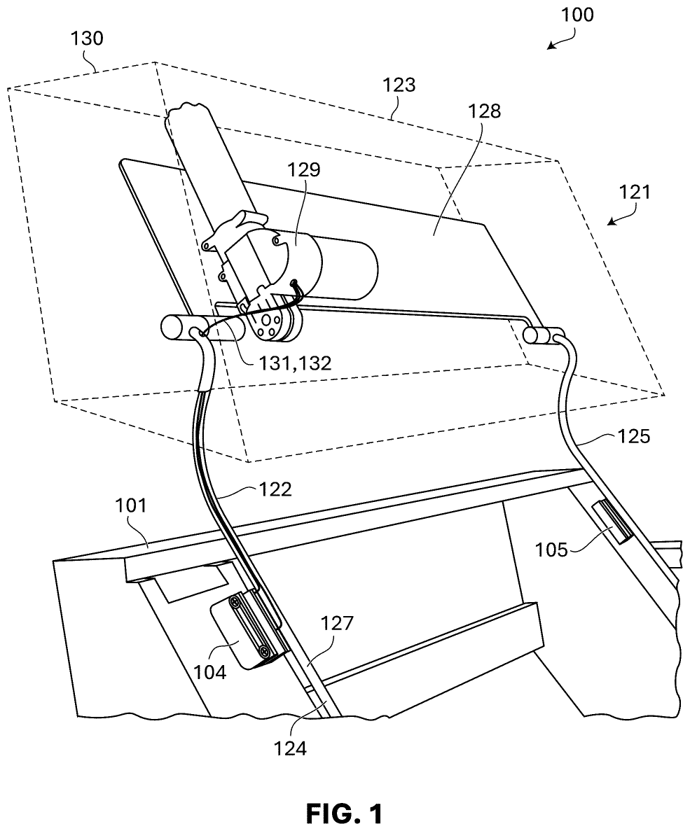

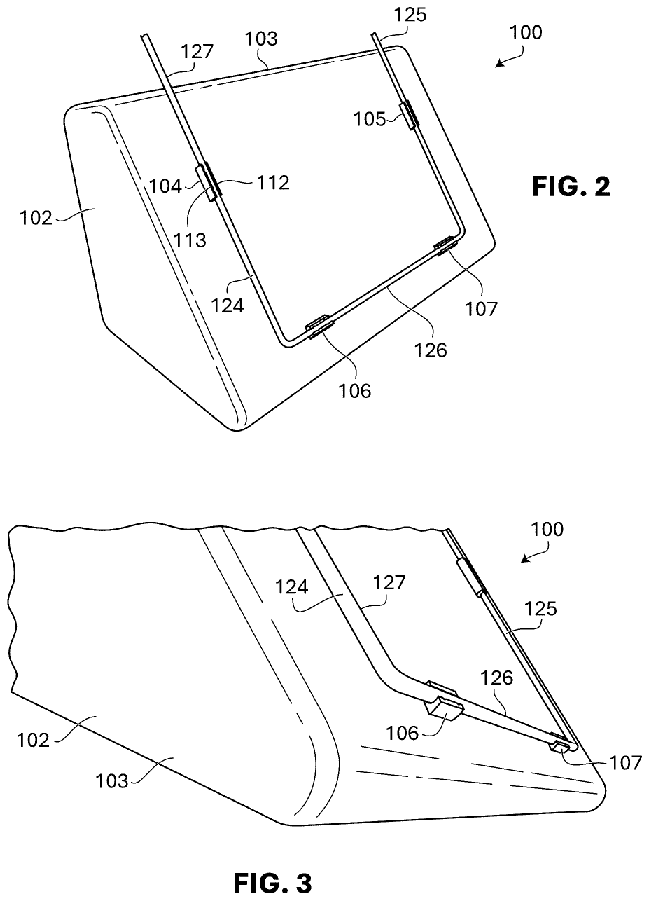

Referring to FIGS. 1 to 3, a furniture system according to one embodiment is shown generally at 100. The furniture system 100 includes a chair-frame portion (or back frame) 101. Cushions or padding, and upholstery 102, may be attached to the chair-frame portion 101 to complete a backrest body 103 (shown in FIGS. 2 and 3) of a chair. In general, “chair” herein may refer to a loveseat, a couch, a sofa, a seat, or another chair or seating apparatus.

The chair-frame portion 101, the backrest body 103, and a chair including the backrest body 103 are examples of furniture apparatuses. However, furniture apparatuses according to alternative embodiments may differ. In some embodiments, a furniture apparatus may include or be some or all of a chair or more generally may include or be some or all of a seating apparatus. In some embodiments, a furniture apparatus may be a seating apparatus that consists of (or consists essentially of) one or more bodies that are configured to facilitate seating on the seating apparatus. In some embodiments, a furniture apparatus may be within a vehicle such as an automobile or other vehicle, attached to a vehicle such as an automobile or other vehicle, or both. In some alternative embodiments, a furniture apparatus may be independent of any vehicle, for example by not being within or attached to any vehicle. In some embodiments, a furniture apparatus may include an upholstered bed or one or more other furniture apparatuses.

Retainers 104, 105, 106, and 107 are coupled to the backrest body 103 (and therefore to a chair including the backrest body 103). Retainers as described herein may also be referred to as clips, and may be or include injection-molded plastic bodies for example.

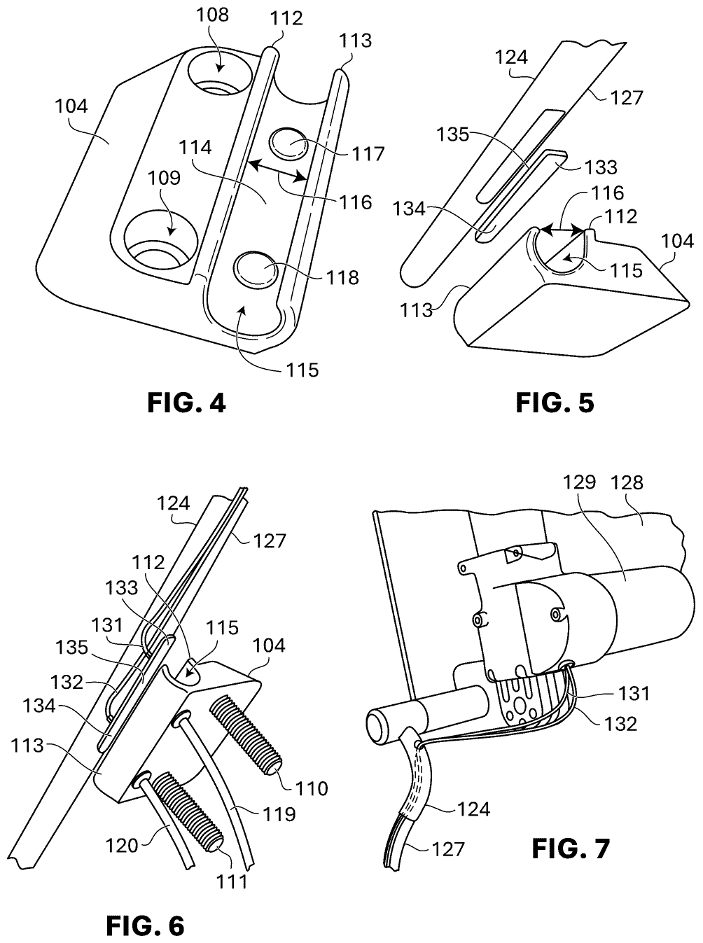

Referring to FIGS. 4 to 6, the retainer 104 defines through-openings shown generally at 108 and 109 and sized to receive respective fasteners (such as machine screws or other fasteners 110 and 111 as shown in FIG. 6) to couple the retainer 104 to the backrest body 103. The retainer 104 also includes retaining bodies 112 and 113. An interior surface 114 of the retainer 104 defines at least part of a space 115 between the retaining bodies 112 and 113. The surface 114 is on the retaining bodies 112 and 113, so the retaining bodies 112 and 113 also at least partially define the space 115. The retaining body 112, the retaining body 113, or both the retaining bodies 112 and 113 are resiliently movable to increase resiliently and decrease resiliently a separation distance 116 between the retaining bodies 112 and 113.

The retainer 104 also includes electrical contacts 117 and 118 between the retaining bodies 112 and 113 and facing into the space 115. The electrical contacts 117 and 118 are therefore electrical contacts on the retainer 104. The electrical contacts 117 and 118 are therefore also electrical contacts of the backrest body 103 or more generally of a furniture apparatus.

The electrical contacts 117 and 118 are electrically coupled with respective electrical conductors 119 and 120 respectively as shown in FIG. 6. In general, two electrical contacts or conductors herein that are “electrically coupled” may be coupled directly or indirectly to each other, with or without one or more intermediate electrical conductors or other components, such that electric voltage and electric current may pass directly or indirectly from one to the other. The electrical conductors 119 and 120 are therefore examples of furniture-apparatus electrical conductors, and some or all of one or both of the electrical conductors 119 and 120 may be enclosed in the backrest body 103 or more generally in a furniture apparatus.

Other retainers described herein, such as the retainers 105, 106, and 107 for example, may be similar to the retainer 104, although some retainers described herein may omit electrical contacts such as the electrical contacts 117 and 118.

A chair including the backrest body 103 may also include one or more sources of electrical power, and the one or more sources of electrical power may be electrically coupled to the electrical conductors 119 and 120 and therefore operable to create or convey an electric potential between the electrical conductors 119 and 120 to provide electric voltage and electric current between the electrical conductors 119 and 120 and between the electrical contacts 117 and 118. Such a source of electrical power may include an alternating-current (AC) power source, a direct-current (DC) power source, an AC-to-DC adapter, one or more electrical conductors, one or more other sources of electrical power, or a combination of two or more thereof. Some or all of such a source of electrical power may be enclosed in the backrest body 103, in a chair including the backrest body 103, or more generally in a furniture apparatus.

For example, in some embodiments, an AC-to-DC adapter may be enclosed in a chair including the backrest body 103, the AC-to-DC adapter may receive AC power from an AC power cable that may be plugged into a wall receptacle, and the electrical conductors 119 and 120 may provide electric voltage and electric current from the AC-to-DC adapter to the electrical contacts 117 and 118. In such embodiments, the AC-to-DC adapter is an example of a source of electrical power of, on, or coupled to a furniture apparatus, and the electrical conductors 119 and 120 are also examples of sources of electrical power of, on, or coupled to a furniture apparatus.

As another example, the electrical conductors 119 and 120 may receive electric voltage and electric current from some source of electrical power outside of a chair including the backrest body 103, or more generally outside of a furniture apparatus. In such embodiments, the electrical conductors 119 and 120 are also examples of sources of electrical power of, on, or coupled to a furniture apparatus.

Additionally or alternatively, a chair including the backrest body 103 may include one or more sources of electrical control signals. For example, such electrical control signals may control one or more electrical loads such as the electrical loads described herein, for example. In some embodiments, for example, such control signals may control movement direction, movement speed, or movement generally of an electric motor or other actuator such as the electric headrest actuator 129 described below or one or more other electric motors or other actuators. In other embodiments, for example, such control signals may control intensity, color, one or more other properties, or two or more thereof of one or more electric light sources such as the electric light sources described below for example. Such control signals may be generated in response to one or more user inputs, for example from one or more switches, one or more mobile devices (for example, using an app on a mobile device), one or more other user-input devices, or any combination of any two or more thereof. In general, sources of electrical power as described herein may additionally or alternatively be sources of electrical control signals or other sources of electric current.

Referring back to FIGS. 1 to 3, a headrest assembly (or wire headrest) is shown generally at 121 and includes a headrest-support body 122 and a headrest 123. The headrest 123 is an example of a furniture accessory, although furniture accessories of alternative embodiments may differ.

The headrest-support body 122 includes an elongate hollow tube including lateral portions 124 and 125 and a transverse portion 126 between the lateral portions 124 and 125. The headrest-support body 122 is an example of an elongate body. However, “body” herein does not necessarily require a distinct body, so the portions 124, 125, and 126 and other portions of the headrest-support body 122 are also examples of elongate bodies.

The headrest-support body 122 has a generally cylindrical exterior surface 127 and is sized such that a portion of the headrest-support body 122 can be received between the retaining bodies 112 and 113 as shown in FIG. 2. However, alternative embodiments may differ. For example, alternative embodiments may have non-cylindrical exterior surfaces.

The retaining bodies 112 and 113 are shaped and positioned such that, as a portion of the lateral portion 124 of headrest-support body 122 is positioned in the space 115, the retaining body 113 moves resiliently to increase the separation distance 116, and after the space 115 receives the portion of the lateral portion 124 of headrest-support body 122, the retaining body 113 moves resiliently to decrease the separation distance 116 such that one or both of the retaining bodies 112 and 113 contact the portion of the lateral portion 124 and retain (releasably or non-releasably) the portion of the lateral portion 124 (or, more generally, an elongate body) in the space 115. In other words, the portion of the lateral portion 124 of headrest-support body 122 may snap into the space 115 to be retained (releasably or non-releasably) in the space 115.

The headrest 123 includes a headrest core 128 pivotably coupled to the headrest-support body 122 at ends of the lateral portions 124 and 125 for rotation relative to the headrest-support body 122. The headrest 123 also includes an electric headrest actuator 129 including one or more electric motors and operable to rotate the headrest core 128 relative to the headrest-support body 122. The electric headrest actuator 129 is an example of an electrical load on the headrest 123 or more generally on a furniture accessory, although electric loads according to alternative embodiments may differ.

The headrest 123 also includes padding and upholstery 130 attached to the headrest core 128 to complete the headrest 123, and the padding and upholstery 130 are rotatable relative to the headrest-support body 122 with the headrest core 128 in response to actuation by the electric headrest actuator 129. The electric headrest actuator 129 can therefore adjust a position of the headrest 123 relative to the headrest-support body 122 (and relative to a chair including the backrest body 103, or more generally relative to a furniture apparatus, when the headrest-support body 122 is coupled to such a chair) by rotating the headrest core 128 relative to the headrest-support body 122. The headrest 123 is therefore coupled to the headrest-support body 122 or more generally to an elongate body.

Referring to FIGS. 1, 6, and 7, the headrest 123 also includes electrical conductors 131 and 132 electrically coupled to the one or more electric motors of the electric headrest actuator 129. The electrical conductors 131 and 132 extend from the electric headrest actuator 129, through the headrest 123, and into the lateral portion 124 of the headrest-support body 122. The electrical conductors 131 and 132 are therefore examples of elongate-body electrical conductors, and some or all of one or both of the electrical conductors 131 and 132 may be enclosed in the lateral portion 124 or more generally in an elongate body.

Referring to FIGS. 5 and 6, the electrical conductors 131 and 132 are electrically coupled with respective electrical contacts 133 and 134 on a contact body 135 of the headrest-support body 122. The electrical contacts 133 and 134 are therefore electrical contacts of the headrest 123 or more generally of a furniture accessory. The electrical contacts 133 and 134 are also electrical contacts on the lateral portion 124 or on an elongate body, and are on the exterior surface 127 of the headrest-support body 122. The electrical contacts 133 and 134 and an exterior surface of the contact body 135 are flush with the exterior surface 127 of the headrest-support body 122.

Referring to FIGS. 2 and 4 to 6, the retainers 106 and 107 are positioned to receive respective portions of the transverse portion 126, positions of the retainers 106 and 107 relative to the retainer 104 define a portion of the lateral portion 124 that may be received by the retainer 104 when the retainers 106 and 107 receive the respective portions of the transverse portion 126, and positions of the retainers 106 and 107 relative to the retainer 105 define a portion of the lateral portion 125 that may be received by the retainer 105 when the retainers 106 and 107 receive the respective portions of the transverse portion 126. Therefore, for example, the headrest assembly 121 may be installed on or coupled to a chair including the backrest body 103 from behind such a chair (namely, on a side of the chair opposite the retainers 104, 105, 106, and 107) by first positioning the respective portions of the transverse portion 126 in the retainers 106 and 107 and then rotating the headrest assembly 121 around the transverse portion 126 and toward the backrest body 103 to position a portion of the lateral portion 124 in the retainer 104 and to position a portion of the lateral portion 125 in the retainer 105.

When the retainers 106 and 107 receive the respective portions of the transverse portion 126 (or more generally respective portions of an elongate body coupled to the headrest 123 or to a furniture accessory), when the retainer 104 receives the portion (defined by the positions of the retainers 106 and 107 relative to the retainer 104) of the lateral portion 124 (or more generally a portion of an elongate body coupled to the headrest 123 or to a furniture accessory), and when the retainer 105 receives the portion (defined by the positions of the retainers 106 and 107 relative to the retainer 105) of the lateral portion 125 (or more generally a portion of an elongate body coupled to the headrest 123 or to a furniture accessory), the headrest-support body 122 (and therefore the headrest 123, or more generally a furniture accessory) may be coupled to the backrest body 103, to a chair including the backrest body 103, or more generally to a furniture apparatus.

In general, a furniture accessory may be coupled to a furniture apparatus directly or indirectly, and coupling a furniture accessory to a furniture apparatus may involve mounting the furniture accessory to the furniture apparatus.

The electrical contacts 117, 118, 133, and 134 are positioned such that, when the retainers 106 and 107 receive the respective portions of the transverse portion 126, and when the retainer 104 receives the portion (defined by the positions of the retainers 106 and 107 relative to the retainer 104) of the lateral portion 124, the electrical contacts 117 and 133 contact each other and become electrically coupled such that the electrical conductors 119 and 131 become electrically coupled, and the electrical contacts 118 and 134 contact each other and become electrically coupled such that the electrical conductors 120 and 132 become electrically coupled.

Therefore, positioning the portion of the lateral portion 124 in the space 115 may cause the electrical contacts 117 and 133 to become electrically coupled and may cause the electrical contacts 118 and 134 to become electrically coupled, which may allow the electric headrest actuator 129 (or more generally an electrical load on a furniture accessory) to receive electric voltage and electric current from a source of electrical power of a chair including the backrest body 103 (or more generally of a furniture apparatus).

Alternative embodiments may differ. For example, in some alternative embodiments, an elongate body such as the lateral portion 124 may be coupled to a furniture apparatus instead of to a furniture accessory. In such embodiments, one or more retainers such as the retainers 104, 105, 106, and 107 may be coupled to a furniture accessory instead of to a furniture apparatus.

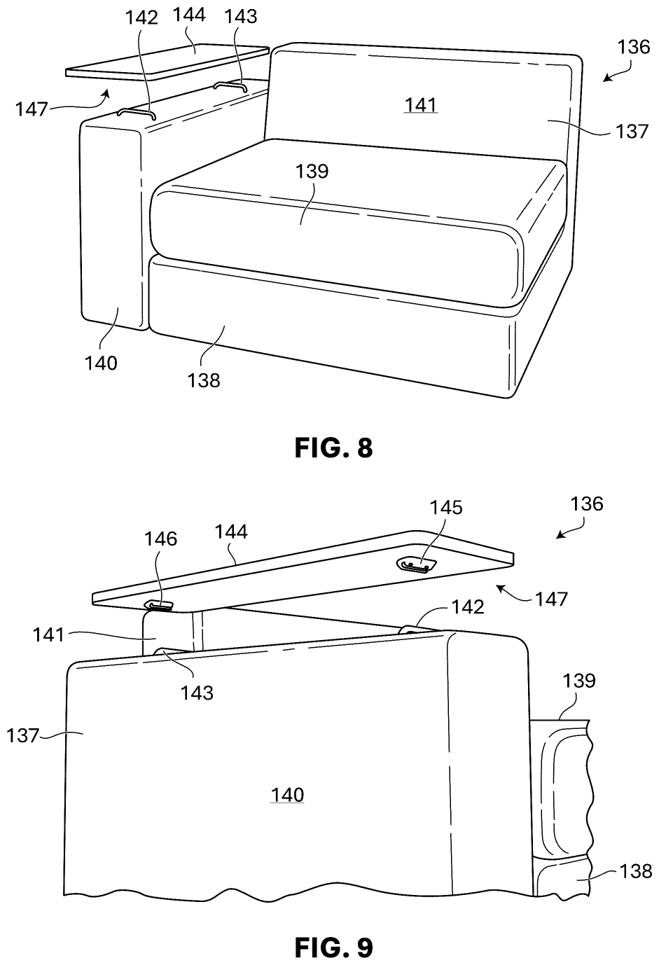

For example, referring to FIGS. 8 to 10, a furniture system according to another embodiment is shown generally at 136 and includes a chair 137. The chair 137 is another example of a seating apparatus or furniture apparatus, and the chair 137 consists of (or consists essentially of) one or more bodies (such as a base body 138, a cushion 139 on the base body 138, an armrest body 140 coupled to the base body 138, and a backrest body 141 coupled to the base body 138) that are configured to facilitate seating on the chair 137. The backrest body 141 may be similar to the backrest body 103.

The armrest body 140 (and therefore the chair 137) includes accessory-support bodies 142 and 143. Like the headrest-support body 122, the accessory-support body 142 includes an elongate hollow tube having a generally cylindrical exterior surface, and the accessory-support body 143 includes an elongate hollow tube having a generally cylindrical exterior surface. The accessory-support body 142, and portions of the accessory-support body 142, are examples of elongate bodies coupled to the chair 137 or more generally to a furniture apparatus. The accessory-support body 143, and portions of the accessory-support body 143, are also examples of elongate bodies coupled to the chair 137 or more generally to a furniture apparatus.

The accessory-support body 142 may include one or more electrical contacts such as the electrical contacts 133 and 134 as described above, for example. Additionally or alternatively, the accessory-support body 143 may include one or more electrical contacts such as the electrical contacts 133 and 134 as described above, for example. One or more electrical contacts on the accessory-support body 142, on the accessory-support body 143, or on both are examples of electrical contacts of the chair 137 or more generally of a furniture apparatus.

Such electrical contacts on the accessory-support body 142, on the accessory-support body 143, or on both may be electrically coupled to one or more respective electrical conductors. Some or all of one or more of such electrical conductors may be enclosed in the armrest body 140 or more generally in the chair 137 or in a furniture apparatus, and one or more of such electrical conductors may be examples of furniture-apparatus electrical conductors similar to the electrical conductors 119 and 120 as described above, for example. Also, some or all of one or more of such electrical conductors may be enclosed in an elongate body (such as some of all of the accessory-support body 142, some of all of the accessory-support body 143, or some of all of both), and one or more of such electrical conductors may be examples of elongate-body electrical conductors similar to the electrical conductors 131 and 132 as described above, for example.

One or more sources of electrical power may be of, on, or coupled to the chair 137 (or more generally to a furniture apparatus) as described herein for example, and the one or more sources of electrical power may create or convey an electric potential between furniture-apparatus electrical conductors of the chair 137 and between electrical contacts of the accessory-support body 142, of the accessory-support body 143, or of both to provide electric voltage and electric current between such electrical contacts.

In general, such electrical contacts may be on the same accessory-support body or on different accessory-support bodies. For example, in some embodiments, one or more sources of electrical power of, on, or coupled to the chair 137 may create or convey an electric potential to provide electric voltage and electric current between one electrical contact of the accessory-support body 142 and one electrical contact of the accessory-support body 143. As another example, in some embodiments, one or more sources of electrical power of, on, or coupled to the chair 137 may create or convey an electric potential to provide electric voltage and electric current between two electrical contacts of the accessory-support body 142 or between two electrical contacts of the accessory-support body 143.

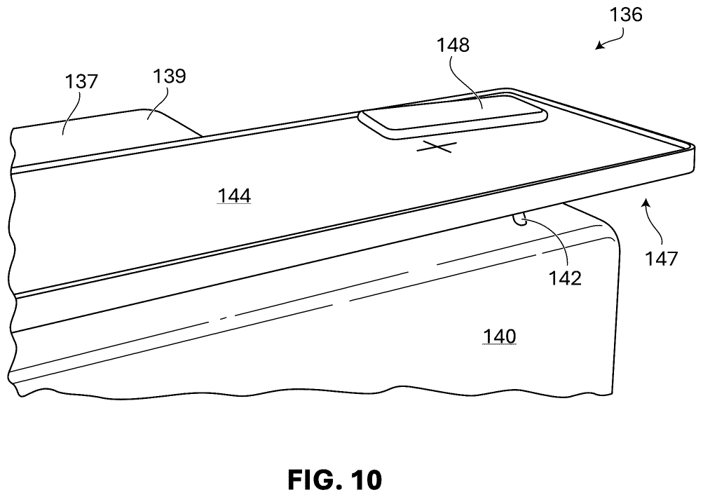

The furniture system 136 also includes a table or tray 144, which is an example of a furniture accessory. Retainers 145 and 146 are coupled to the table or tray 144 on a bottom side shown generally 147 of the table or tray 144. One or both of the retainers 145 and 146 may be similar to the retainer 104 as described above and may include one or more electrical contacts such as the electrical contacts 117 and 118 as described above, for example. One or more electrical contacts on the retainer 145, on the retainer 146, or on both are examples of electrical contacts of the table or tray 144 or more generally of a furniture accessory. The table or tray 144 may include an electrical load. For example, as shown in FIG. 10, the table or tray 144 in the embodiment shown includes an electric battery charger, which may be configured to charge a device (a mobile device 148 in the embodiment shown), and which may be configured to charge such a device wirelessly. An electrical load on the table or tray 144 may be electrically coupled to the one or more electrical contacts on the retainer 145, on the retainer 146, or on both allow the electrical load to receive electric voltage and electric current from such one or more electrical contacts.

The accessory-support bodies 142 and 143 and the retainers 145 and 146 may be positioned such that, when a portion of the accessory-support body 142 is received in a space (similar to the space 115 as described above, for example) of the retainer 145, a portion of the accessory-support body 143 may be received in a space (similar to the space 115 as described above, for example) of the retainer 146 to couple the table or tray 144 to the chair 137.

Further, one or more electrical contacts of the chair 137 and one or more electrical contacts of the table or tray 144 may be positioned such that positioning a portion of the accessory-support body 142 in a space (similar to the space 115 as described above, for example) of the retainer 145, positioning a portion of the accessory-support body 143 in a space (similar to the space 115 as described above, for example) of the retainer 146, or both causes the one or more electrical contacts of the chair 137 to become electrically coupled with respective one or more electrical contacts of the table or tray 144, which may allow the electric battery charger of the table or tray 144 (or more generally an electrical load on a furniture accessory) to receive electric voltage and electric current from a source of electrical power of the chair 137 (or more generally of a furniture apparatus).

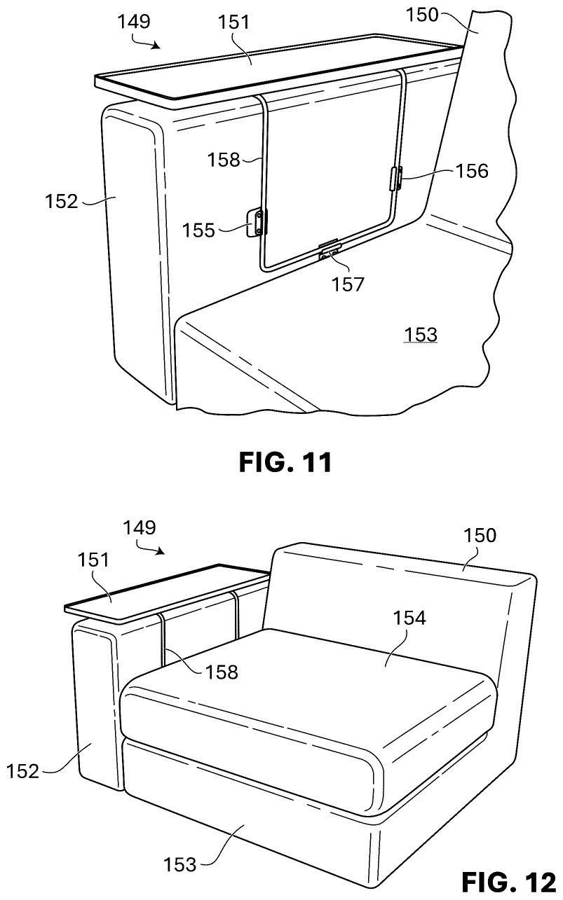

Referring to FIGS. 11 and 12, a furniture system according to another embodiment is shown generally at 149 and includes a chair 150 and a table or tray 151.

The chair 150 may be similar to the chair 137 and may include an armrest body 152, a base body 153, and a cushion 154. The chair 150 is an example of a furniture apparatus. The base body 153 may be similar to the base body 138. The armrest body 152 may be similar to the armrest body 140, but unlike the armrest body 140, the armrest body 152 includes retainers 155, 156, and 157 coupled to the armrest body 152 and positioned to be concealed by the cushion 154 when the cushion 154 is on the base body 153 as shown in FIG. 12.

In the embodiment shown, the retainer 155 may function similarly to the retainer 104 as described above, the retainer 156 may function similarly to the retainer 105 as described above, and the retainer 157 may function similarly to the retainers 106 and 107 as described above. As in other embodiments described herein, one, more than one, or all of the retainers 155, 156, and 157 may include one or more electrical contacts such as the electrical contacts 117 and 118 as described above, for example, and such one or more electrical contacts are examples of electrical contacts of the chair 150 or more generally of a furniture apparatus. Further, as in other embodiments described herein, such one or more electrical contacts may be electrically coupled to one or more respective electrical conductors, which may be examples of furniture-apparatus electrical conductors similar to the electrical conductors 119 and 120 as described above for example, and which may receive an electric potential from one or more sources of electrical power of the chair 150.

The table or tray 151 may be similar to the table or tray 144 and is another example of a furniture accessory. However, unlike the table or tray 144, the table or tray 151 is coupled to a support body 158 that may be similar to the headrest-support body 122. As in other embodiments described herein, the support body 158 may include or be an elongate body. Like the headrest assembly 121 as described above, the table or tray 151 may be installed on or coupled to the chair 150 by first positioning a portion of the support body 158 in the retainer 157 and then rotating the table or tray 151 and the support body 158, around the portion of the support body 158 in the retainer 157, to position another portion of the support body 158 in the retainer 155 and to position another portion of the support body 158 in the retainer 156.

Further, as in other embodiments described herein, the support body 158 may include one or more electrical contacts such as the electrical contacts 133 and 134 as described above, for example, and such one or more electrical contacts are electrical contacts of the table or tray 151 or more generally of a furniture accessory. Further, as in other embodiments described herein, such one or more electrical contacts may be electrically coupled to one or more respective electrical conductors, which may be examples of elongate-body electrical conductors similar to the electrical conductors 131 and 132 as described above, for example.

As in other embodiments described herein, positioning respective portions of the support body 158 in respective spaces (similar to the space 115 as described above, for example) of the retainers 155, 156, and 157 may couple the table or tray 151 to the chair 150 and may cause the one or more electrical contacts of the chair 150 to become electrically coupled with respective one or more electrical contacts of the table or tray 151, which may allow the electric battery charger of the table or tray 151 (or more generally an electrical load on a furniture accessory) to receive electric voltage and electric current from a source of electrical power of the chair 150 (or more generally of a furniture apparatus).

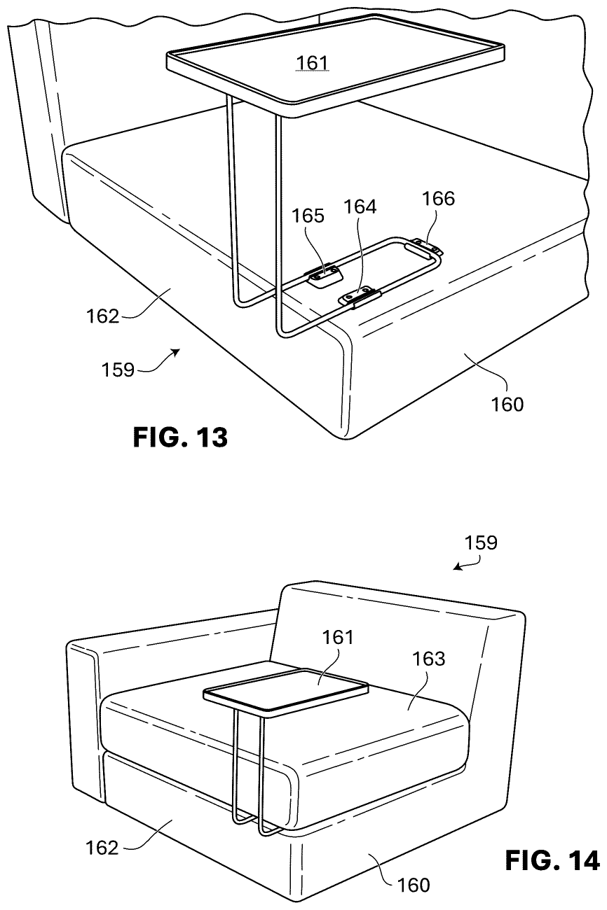

Referring to FIGS. 13 and 14, a furniture system according to another embodiment is shown generally at 159 and includes a chair 160 and a table or tray 161.

The chair 160 may be similar to the chair 150 and may include a base body 162 and a cushion 163. The chair 160 is an example of a furniture apparatus. The base body 162 may be similar to the base body 138, but unlike the base body 138, the base body 162 includes retainers 164, 165, and 166 that may be similar to the retainers 155, 156, and 157 respectively but coupled to the base body 162 and positioned to be concealed by the cushion 163 when the cushion 163 is on the base body 162 as shown in FIG. 14. The table or tray 161 may be similar to the table or tray 151 and is another example of a furniture accessory, and the furniture system 159 may otherwise be similar to the furniture system 149 as described above.

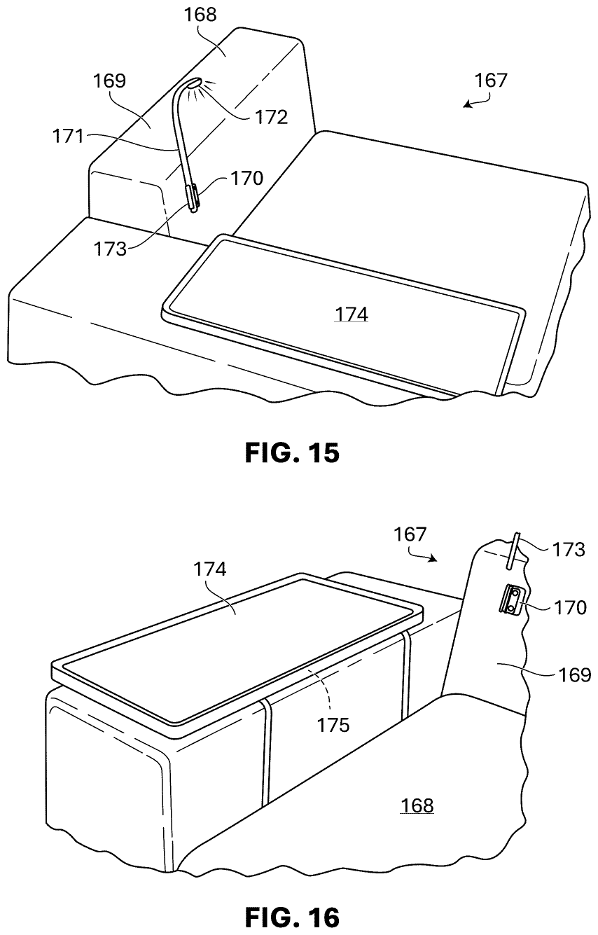

Referring to FIGS. 15 and 16, a furniture system according to another embodiment is shown generally at 167 and includes a chair 168, which is an example of a furniture apparatus. The chair 168 may be similar to the chair 150 and may include a backrest body 169 that may be similar to the backrest body 103 or 141. The backrest body 169 includes a retainer 170 that may be similar to the retainer 104. For example, the retainer 170 may include one or more electrical contacts such as the electrical contacts 117 and 118 as described above, for example, and such one or more electrical contacts are examples of electrical contacts of the chair 168 or more generally of a furniture apparatus. Further, as in other embodiments described herein, such one or more electrical contacts may be electrically coupled to one or more respective electrical conductors, which may be examples of furniture-apparatus electrical conductors similar to the electrical conductors 119 and 120 as described above for example, and which may receive an electric potential from one or more sources of electrical power of the chair 168.

The system 167 also includes a lighting apparatus 171 including an electric light source 172. The lighting apparatus 171 is an example of a furniture accessory. The electric light source 172 may include one or more light-emitting diodes (LEDs), one or more incandescent light bulbs, one or more halogen light bulbs, one or more other electric light sources, or a combination of two or more thereof, and the electric light source 172 is an example of an electrical load on the lighting apparatus 171 or more generally on a furniture accessory.

The lighting apparatus 171 also includes an elongate body 173 that may include one or more electrical contacts such as the electrical contacts 133 and 134 as described above for example, and such one or more electrical contacts are electrical contacts of the lighting apparatus 171 or more generally of a furniture accessory. Further, as in other embodiments described herein, such one or more electrical contacts may be electrically coupled to one or more respective electrical conductors, which may be examples of elongate-body electrical conductors similar to the electrical conductors 131 and 132 as described above, for example. Such one or more electrical conductors may electrically couple the electric light source 172 (or more generally an electrical load on a furniture accessory) to the one or more electrical contacts on the lighting apparatus 171.

As in other embodiments described herein, positioning a portion of the elongate body 173 in a space (similar to the space 115 as described above, for example) of the retainer 170 may couple the lighting apparatus 171 to the chair 168 and may cause one or more electrical contacts of the chair 168 to become electrically coupled with respective one or more electrical contacts of the lighting apparatus 171, which may allow the electric light source 172 of the lighting apparatus 171 (or more generally an electrical load on a furniture accessory) to receive electric voltage and electric current from a source of electrical power of the chair 168 (or more generally of a furniture apparatus).

The system 167 also includes a table or tray 174, which may be similar to the table or tray 151 or 161, and which is another example of a furniture accessory. However, the table or tray 174 includes an electric light source 175 within the table or tray 174. Like the electric light source 172, the electric light source 175 may include one or more LEDs, one or more incandescent light bulbs, one or more halogen light bulbs, one or more other electric light sources, or a combination of two or more thereof, and the electric light source 175 is an example of an electrical load on the table or tray 174 or more generally on a furniture accessory. The electric light source 175 may, in operation, transmit light through an exterior surface of the table or tray 174. The exterior surface of the table or tray 174 may be partly or entirely translucent or transparent.

In general, a table or tray as described herein may include an electric battery charger on the table or tray as described herein, an electric light source on the table or tray such as the electric light source 175, one or more other electrical loads on the table or tray, or a combination of two or more thereof, and one or more such electrical loads on the table or tray may receive electric voltage and electric current from one or more sources of electrical power of a furniture apparatus such as the chair 137, 150, 160, or 168, for example.

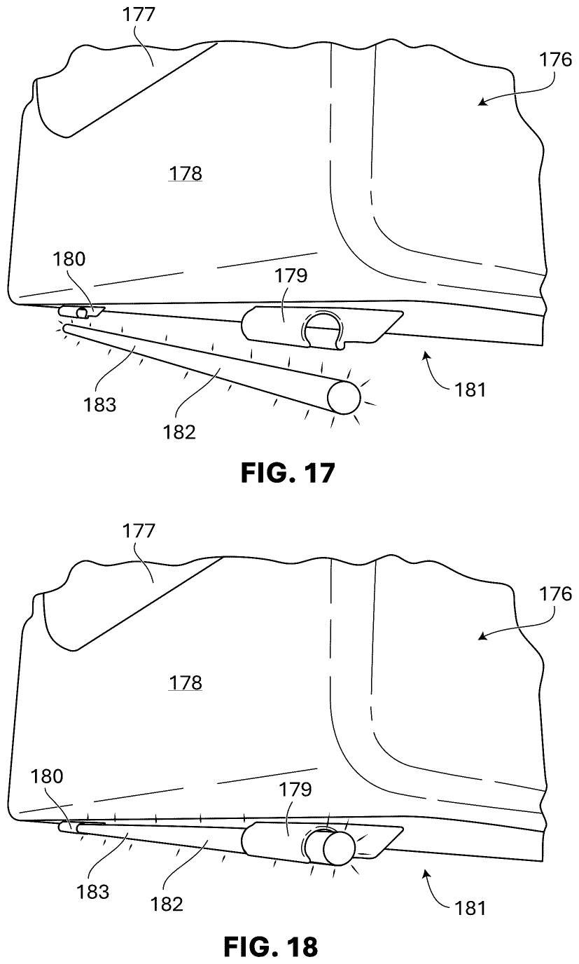

Referring to FIGS. 17 and 18, a furniture system according to another embodiment is shown generally at 176 and includes a chair 177, which is an example of a furniture apparatus. The chair 177 may be similar to the chair 150 and may include a base body 178. The base body 178 may be similar to the base body 138, but retainers 179 and 180 are coupled to the base body 178 on a bottom side shown generally at 181 of the base body 178. One or both of the retainers 179 and 180 may be similar to the retainer 104 as described above. Therefore, as in other embodiments described herein, one or both of the retainers 179 and 180 may include one or more electrical contacts such as the electrical contacts 117 and 118 as described above, for example, and such one or more electrical contacts are examples of electrical contacts of the chair 177 or more generally of a furniture apparatus. Further, as in other embodiments described herein, such one or more electrical contacts may be electrically coupled to one or more respective electrical conductors, which may be examples of furniture-apparatus electrical conductors similar to the electrical conductors 119 and 120 as described above for example, and which may receive an electric potential from one or more sources of electrical power of the chair 177.

The system 176 also includes a lighting apparatus 182 including an electric light source within the lighting apparatus 182. The lighting apparatus 182 is or includes an elongate body having a generally cylindrical exterior surface 183, and the lighting apparatus 182 is another example of a furniture accessory. The exterior surface of the lighting apparatus 182 may be partly or entirely translucent or transparent. The electric light source within the lighting apparatus 182 may include one or more LEDs, one or more incandescent light bulbs, one or more halogen light bulbs, one or more other electric light sources, or a combination of two or more thereof, and the electric light source within the lighting apparatus 182 is an example of an electrical load on the lighting apparatus 182 or more generally on a furniture accessory. The electric light source within the lighting apparatus 182 may, in operation, transmit light through some or all the generally cylindrical exterior surface 183.

The lighting apparatus 182 may include one or more electrical contacts such as the electrical contacts 133 and 134 as described above for example, and such one or more electrical contacts are electrical contacts of the lighting apparatus 182 or more generally of a furniture accessory. Further, as in other embodiments described herein, such one or more electrical contacts may be electrically coupled to one or more respective electrical conductors, which may be examples of elongate-body electrical conductors similar to the electrical conductors 131 and 132 as described above, for example. Such one or more electrical conductors may electrically couple the electric light source within the lighting apparatus 182 (or more generally an electrical load on a furniture accessory) to the one or more electrical contacts on the lighting apparatus 182.

As in other embodiments described herein, positioning respective portions of the lighting apparatus 182 in respective spaces (similar to the space 115 as described above, for example) of the retainers 179 and 180 may couple the lighting apparatus 182 to the chair 177 and may cause one or more electrical contacts of the chair 177 to become electrically coupled with respective one or more electrical contacts of the lighting apparatus 182, which may allow the electric light source of the lighting apparatus 182 (or more generally an electrical load on a furniture accessory) to receive electric voltage and electric current from a source of electrical power of the chair 177 (or more generally of a furniture apparatus).

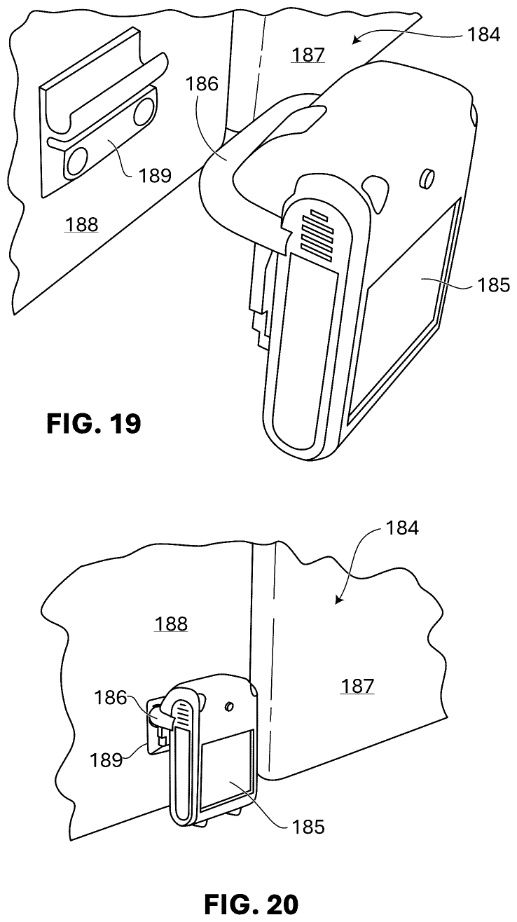

Referring to FIGS. 19 and 20, a furniture system according to another embodiment is shown generally at 184 and includes an electric power source 185, which is an example of a furniture accessory. The electric power source 185 includes an electric battery, which may include one or more electrochemical cells or other sources of electric power.

The electric power source 185 also includes a support body or coupling body 186 that may be similar to the accessory-support body 142 or the accessory-support body 143 and may include or be an elongate body. Therefore, the support body or coupling body 186 may include one or more electrical contacts such as the electrical contacts 133 and 134 as described above for example, and such one or more electrical contacts are electrical contacts of the electric power source 185 or more generally of a furniture accessory. Further, as in other embodiments described herein, such one or more electrical contacts may be electrically coupled to one or more respective electrical conductors, which may be examples of elongate-body electrical conductors similar to the electrical conductors 131 and 132 as described above, for example. Such one or more electrical conductors may electrically couple the electric battery of the electric power source 185 to the one or more electrical contacts on the electric power source 185.

The system 184 also includes a chair 187, which is an example of a furniture apparatus. The chair 187 may be similar to the chair 150, and one or more furniture accessories (such as the headrest 123, the table or tray 144, 151, 161, or 174, or the lighting apparatus 182, for example) may include one or more electrical loads (such as the electric headrest actuator 129, an electric battery charger of a table or tray, the electric light source 172 or 175, or the electric light source of the lighting apparatus 182, for example) and may be coupled to the chair 187 as described above, for example. Additionally or alternatively, the chair 187 may include one or more electrical loads (such as the electric headrest actuator 129, an electric battery charger of a table or tray, the electric light source 172 or 175, or the electric light source of the lighting apparatus 182, for example).

The chair 187 may include a base body 188. The base body 188 may be similar to the base body 138, but a retainer 189 is coupled to the base body 188 and may be similar to the retainer 104 as described above. For example, the retainer 189 may include one or more electrical contacts such as the electrical contacts 117 and 118 as described above, for example, and such one or more electrical contacts are examples of electrical contacts of the chair 187 or more generally of a furniture apparatus. Further, as in other embodiments described herein, such one or more electrical contacts may be electrically coupled to one or more respective electrical conductors, which may be examples of furniture-apparatus electrical conductors similar to the electrical conductors 119 and 120 as described above for example. Furniture-apparatus electrical conductors of the chair 187 may receive an electric potential from electrical contacts of the retainer 189, which may receive an electric potential from electrical contacts of the support body or coupling body 186, which may receive an electric potential from the electric battery of the electric power source 185.

Therefore, as in other embodiments described herein, positioning a portion of the support body or coupling body 186 in a space (similar to the space 115 as described above, for example) of the retainer 189 may couple the electric power source 185 to the chair 187 and may cause the one or more electrical contacts of the electric power source 185 to become electrically coupled with respective electrical contacts of the chair 187.

Causing the one or more electrical contacts of the electric power source 185 to become electrically coupled with respective electrical contacts of the chair 187 may allow one or more electrical loads (such as the electric headrest actuator 129, an electric battery charger of a table or tray, the electric light source 172 or 175, or the electric light source of the lighting apparatus 182, for example) on one or more furniture accessories (such as the headrest 123, the table or tray 144, 151, 161, or 174, or the lighting apparatus 182, for example) coupled to the chair 187 to receive electric voltage and electric current from the electric battery of the electric power source 185. Additionally or alternatively, causing the one or more electrical contacts of the electric power source 185 to become electrically coupled with respective electrical contacts of the chair 187 may allow one or more electrical loads of the chair 187 to receive electric voltage and electric current from the electric battery of the electric power source 185.

Therefore, the electric power source 185 is an example of a furniture accessory and is also an example of a source of electrical power of, on, or coupled to the chair 187 (or more generally a furniture apparatus), and the electric power source 185 may allow one or more electrical loads as described above to be battery-powered by the electric battery of the electric power source 185.

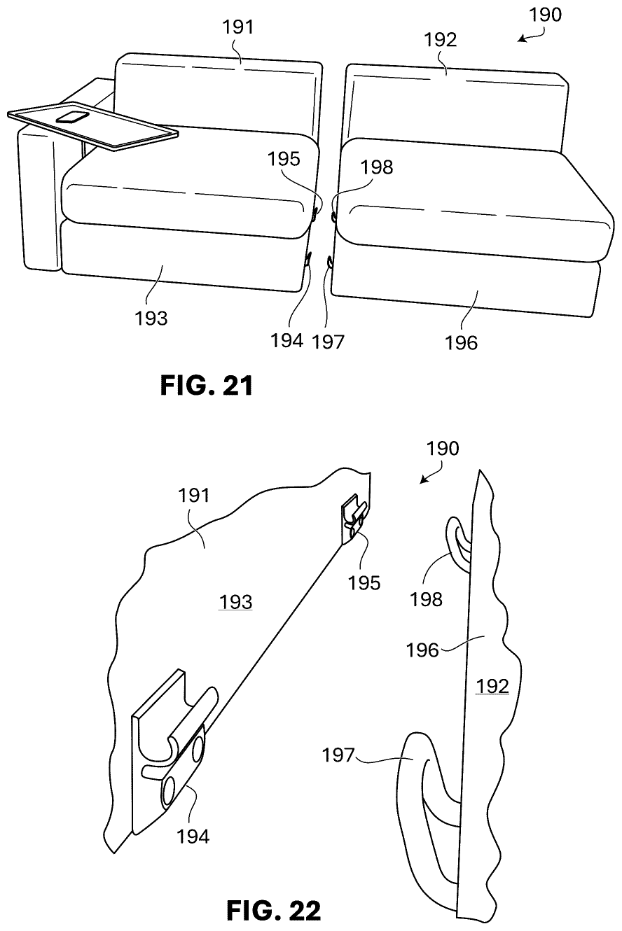

Referring to FIGS. 21 and 22, a furniture system according to another embodiment is shown generally at 190 and includes chairs 191 and 192. The chair 191 may be similar to the chair 150 and may include a base body 193. The base body 193 may be similar to the base body 138, but retainers 194 and 195 are coupled to the base body 193 on a side of the base body 193 positioned to face the chair 192. One or both of the retainers 194 and 195 may be similar to the retainer 104 as described above. Therefore, as in other embodiments described herein, one or both of the retainers 194 and 195 may include one or more electrical contacts such as the electrical contacts 117 and 118 as described above, for example, and such one or more electrical contacts are examples of electrical contacts of the chair 191. Further, as in other embodiments described herein, such one or more electrical contacts may be electrically coupled to one or more respective electrical conductors, which may be examples of furniture-apparatus electrical conductors similar to the electrical conductors 119 and 120 as described above for example.

The chair 192 may be similar to the chair 150 but may omit an armrest body (such as the armrest body 140) and may include a base body 196. The base body 196 may be similar to the base body 138, but coupling bodies 197 and 198 are coupled to the base body 196 on a side of the base body 196 positioned to face the chair 191. One or both of the coupling bodies 197 and 198 may be similar to the accessory-support body 142 or the accessory-support body 143 and may include or be an elongate body. Therefore, one or both of the coupling bodies 197 and 198 may include one or more electrical contacts such as the electrical contacts 133 and 134 as described above for example, and such one or more electrical contacts are electrical contacts of the chair 192. Further, as in other embodiments described herein, such one or more electrical contacts may be electrically coupled to one or more respective electrical conductors, which may be examples of furniture-apparatus electrical conductors similar to the electrical conductors 119 and 120 as described above for example.

The retainers 194 and 195 and the coupling bodies 197 and 198 may be positioned such that, when a portion of the coupling body 197 is received in a space (similar to the space 115 as described above, for example) of the retainer 194, a portion of the coupling body 198 may be received in a space (similar to the space 115 as described above, for example) of the retainer 195 to couple the chairs 191 and 192.

Further, one or more electrical contacts of the chair 191 and one or more electrical contacts of the chair 192 may be positioned such that positioning a portion of the coupling body 197 in a space (similar to the space 115 as described above, for example) of the retainer 194, positioning a portion of the coupling body 198 in a space (similar to the space 115 as described above, for example) of retainer 195, or both causes the one or more electrical contacts of the chair 191 to become electrically coupled with respective one or more electrical contacts of the chair 192.

Therefore, for example, one or more electrical loads (such as the electric headrest actuator 129, an electric battery charger of a table or tray, the electric light source 172 or 175, or the electric light source of the lighting apparatus 182, for example) on one or more furniture accessories (such as the headrest 123, the table or tray 144, 151, 161, or 174, or the lighting apparatus 182, for example) coupled to the chair 191 may receive electric voltage and electric current from a source of electrical power of, on, or coupled to the chair 192. Additionally or alternatively, the chair 191 may include one or more electrical loads (such as the electric headrest actuator 129, an electric battery charger of a table or tray, the electric light source 172 or 175, or the electric light source of the lighting apparatus 182, for example), and such one or more electrical loads of the chair 191 (or more generally of a furniture apparatus) may receive electric voltage and electric current from a source of electrical power of, on, or coupled to the chair 192. In such examples, the chair 192 may be an example of a furniture accessory.

Also, as another example, one or more electrical loads (such as the electric headrest actuator 129, an electric battery charger of a table or tray, the electric light source 172 or 175, or the electric light source of the lighting apparatus 182, for example) on one or more furniture accessories (such as the headrest 123, the table or tray 144, 151, 161, or 174, or the lighting apparatus 182, for example) coupled to the chair 192 to receive electric voltage and electric current from a source of electrical power of, on, or coupled to the chair 191 (or more generally a furniture apparatus). Additionally, or alternatively, the chair 192 may include one or more electrical loads (such as the electric headrest actuator 129, an electric battery charger of a table or tray, the electric light source 172 or 175, or the electric light source of the lighting apparatus 182, for example), and such one or more electrical loads of the chair 192 (or more generally of a furniture apparatus) may receive electric voltage and electric current from a source of electrical power of, on, or coupled to the chair 191. In such examples, the chair 191 may be an example of a furniture accessory.

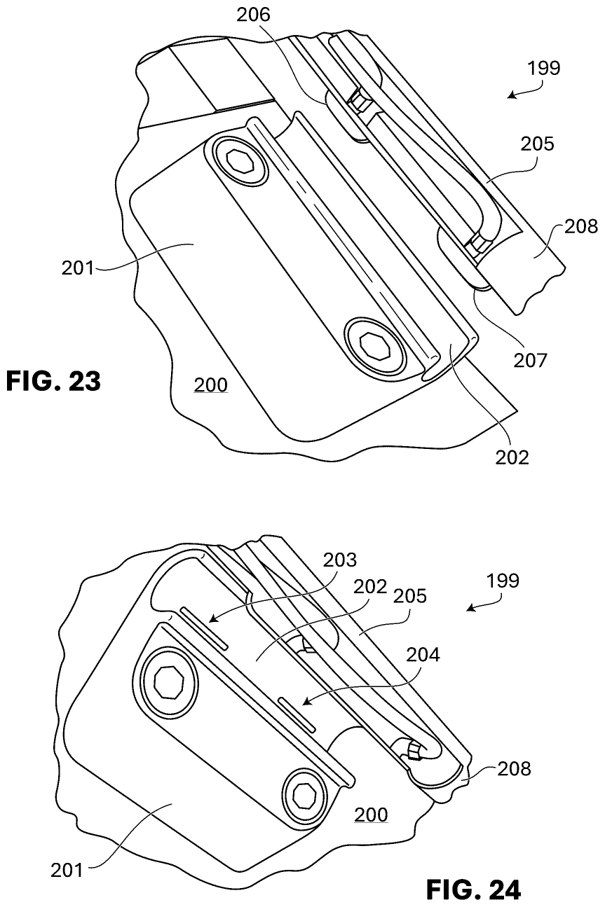

Referring to FIGS. 23 and 24, a furniture system according to another embodiment is shown generally at 199 and includes a furniture apparatus 200. The furniture apparatus 200 may be a chair-frame portion such as the chair-frame portion 101 described above, or any other furniture apparatus. A retainer 201 is coupled to the furniture apparatus 200. The retainer 201 may be similar to the retainer 104 as described above and includes an interior surface 202 that may be similar to the interior surface 114. The retainer 201 also includes electrical contacts that may be similar to the electrical contacts 117 and 118 as described above, although the electrical contacts on the retainer 201 are recessed in respective recesses shown generally at 203 and 204 behind the surface 202. Recessing the electrical contacts on the retainer 201 behind the surface 202 may prevent or avoid unintentional electrical connections with the electrical contacts on the retainer 201.

In the embodiment shown, an elongate body 205 may be similar to elongate bodies as described herein, but electrical contacts 206 and 207 on the elongate body 205 may be protrusions from a generally cylindrical exterior surface 208 (that may be similar to the exterior surface 127 as described above) of the elongate body 205. The electrical contacts 206 and 207 may be sized and positioned to contact respective electrical contacts on the retainer 201 when a space defined by the surface 202 receives a portion of the elongate body 205 as described herein regarding other embodiments. The retainer 201 and the elongate body 205 may otherwise function as described herein regarding other embodiments.

Alternative embodiments may differ. For example, in some embodiments, one or more electrical contacts on a retainer as described herein may be protrusions into a space defined by the retainer, and one or more electrical contacts on an elongate body as described herein may be recessed behind an exterior surface of the elongate body. Other embodiments such as those described herein may include a retainer similar to the retainer 201, a retainer on which one or more electrical contacts are protrusions into a space defined by the retainer, or another retainer. Also, other embodiments such as those described herein may include an elongate body similar to the elongate body 205, an elongate body on which one or more electrical contacts are recessed behind an exterior surface of the elongate body, or another elongate body.

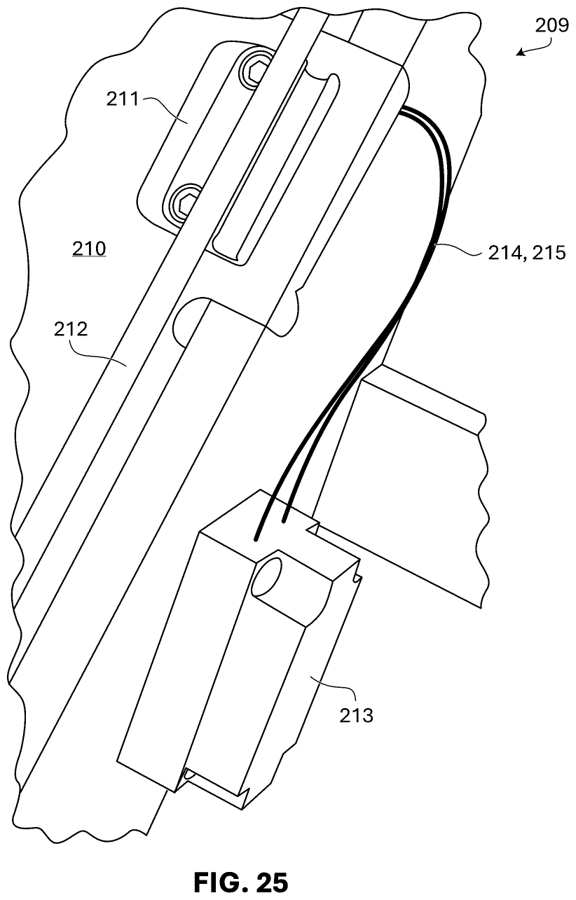

Referring to FIG. 25, a furniture system according to another embodiment is shown generally at 209 and includes a furniture apparatus 210. The furniture apparatus 210 may be a chair-frame portion such as the chair-frame portion 101 described above, or any other furniture apparatus. A retainer 211 is coupled to the furniture apparatus 210 and may be similar to the retainer 104. An elongate body 212 may be similar to elongate bodies as described herein regarding other embodiments. The retainer 211 and the elongate body 212 may otherwise function as described herein regarding other embodiments.

The system 209 also includes a controller device 213. The controller device 213 may include one or more electrical circuits or processors (such as one or more central processing unit (CPUs) or microprocessors, one or more machine learning chips, one or more discrete logic circuits, or one or more application-specific integrated circuit (ASICs), or combinations of two or more thereof). Such one or more processors may also include one or more of the same or different computer-readable storage media, which in various embodiments may include one or more read-only memory (ROM), one or more random access memory (RAM), one or more hard disc drive (HDD), one or more solid-state drive (SSD), or one or more other computer-readable and/or computer-writable storage media, or combinations of two or more thereof. Such one or more such computer-readable storage media may store program codes that, when executed by the one or more processors, cause the one or more processors to, at least, implement functions including but not limited to functions as described herein. The controller device 213 may be programmed, configured, or operable to implement at least such functions in other ways.

The controller device 213 may be part of a source of electrical power. For example, the controller device 213 may receive electrical power from an AC power source, a DC power source, an AC-to-DC adapter, one or more electrical conductors, one or more other sources of electrical power, or a combination of two or more thereof. Further, the controller device 213 may be electrically coupled to electrical conductors 214 and 215, which may be similar to the electrical conductors 119 and 120 are therefore other examples of furniture-apparatus electrical conductors. The electrical conductors 214 and 215 are electrically coupled with respective electrical contacts on the retainer 211. Therefore, the controller device 213 may control electrical power available to electrical contacts on the retainer 211, which may convey electrical power, from or controlled by the controller device 213, to electrical contacts on the elongate body 212 and to one or more electrical loads as described herein regarding other embodiments, for example. Therefore, a source of electrical power including the controller device 213 may be electrically coupled to an electrical load by positioning a portion of the elongate body 212 in a space defined by the retainer 211 or more generally by positioning a portion of an elongate body in a space defined by a retainer as described herein regarding other embodiments.

The controller device 213 may be operable, programed, or configured to detect whether an authorized electrical load is electrically coupled to a source of electrical power including the controller device 213, for example by positioning a portion of an elongate body in a space defined by a retainer as described herein regarding other embodiments. In some embodiments, an authorized electrical load may have a known or knowable electrical constant or variable resistance or impedance, may produce one or more known or knowable electrical signals, or both, or the controller device 213 may otherwise detect electrical connection with the authorized electrical load. The controller device 213 may detect such known or knowable electrical resistance, impedance, or signals, for example, and direct electrical power to the electrical contacts on the retainer 211 in response to detecting the at least one authorized electrical load, or only when electrical coupling to such an authorized electrical load is detected. The controller device 213 may therefore prevent or avoid unintentional electrical connections with the electrical contacts on the retainer 211.

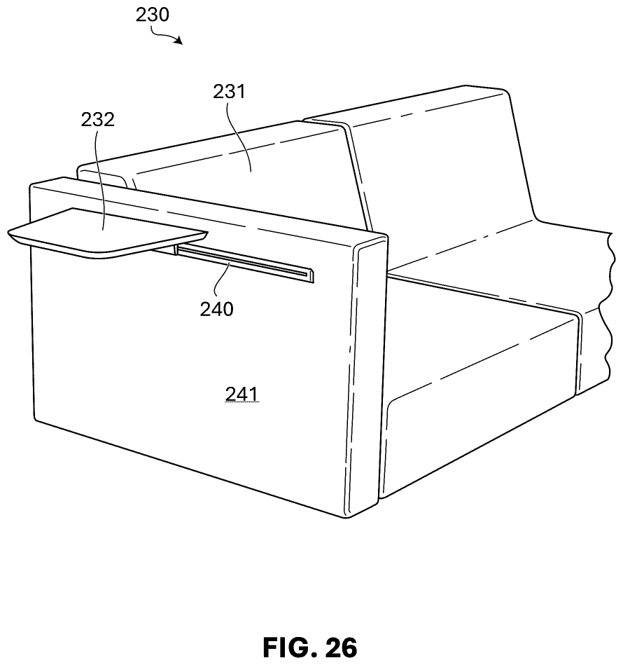

Referring to FIGS. 26 to 30, a furniture system according to another embodiment is shown generally at 230 and includes a furniture apparatus 231 and a furniture accessory 232. The furniture apparatus 231 may include a chair such as chair 191 described above, or any other furniture apparatus. The furniture accessory 232 may include a table or tray such as table or tray 174 described above, or any other furniture accessory.

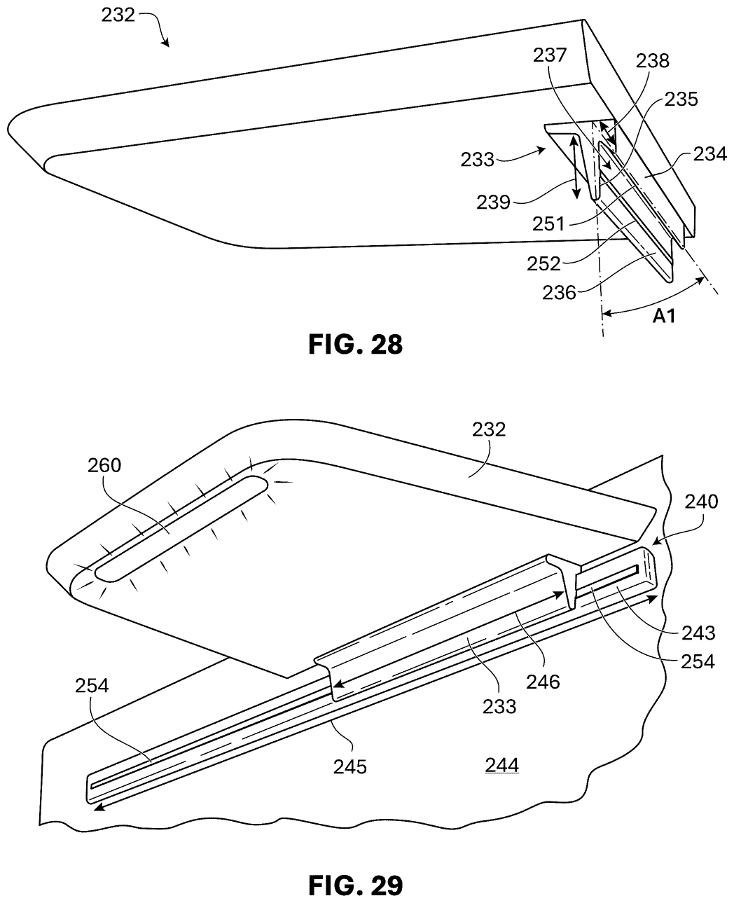

A retainer 233 may be coupled to the furniture accessory 232. As shown in FIG. 28, retainer 233 includes retaining bodies 234 and 235. An interior surface 236 of the retainer 233 defines at least part of a space 237 between the retaining bodies 234 and 235. The surface 236 is on the retaining bodies 234 and 235, so the retaining bodies 234 and 235 also at least partially define the space 237. In some embodiments, retainer 233 is coupled to a bottom surface of the furniture accessory 232.

The retaining body 234 may be at an offset angle A1 from the retaining body 235. As such, the portion of the surface 236 defined by the retaining body 234 may be at the offset angle A1 from the portion of the surface 236 defined by the retaining body 235. In some embodiments, the retaining bodies 234 and 235 are different from one another. In some embodiments, the retaining body 234 has a length 238 that is shorter than a length 239 of the retaining body 235.

In some embodiments, the retainer 233 includes or is a French cleat.

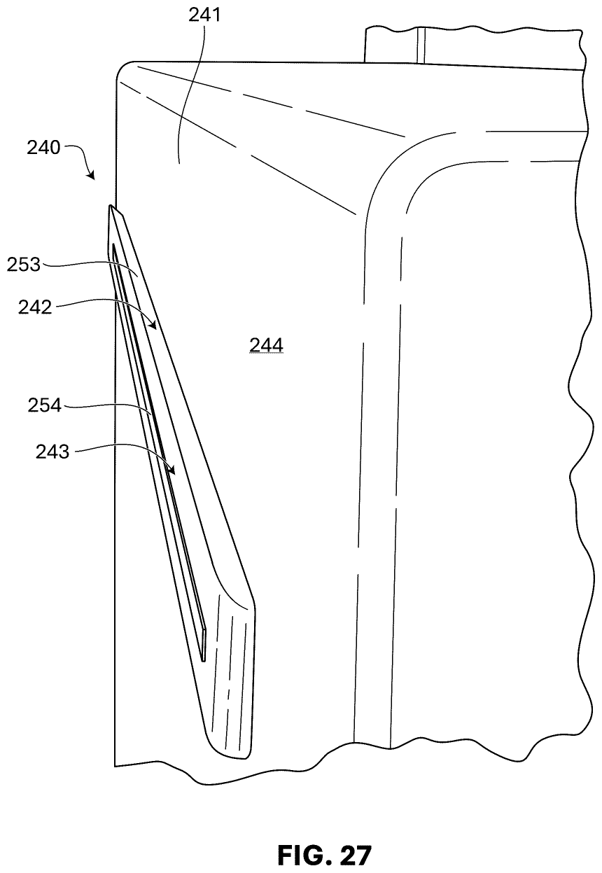

As shown in FIG. 27, a mating member 240 may be coupled to the furniture apparatus 231, for example, to an armrest body 241 of the furniture apparatus 231. In some embodiments, the mating member 240 includes or is a mating cleat. The mating member 240 may extend laterally across the armrest body 241. The mating member 240 may include or be an elongate body.

The mating member 240 may comprise faces 242 and 243. Face 242 may be at an angle from face 243. Face 242 may be angularly offset from face 243 at the same offset angle A1 at which the retaining body 234 is offset from the retaining body 235. Face 243 may be parallel to an outward face 244 of the armrest body 241. An exterior surface of mating member 240 may include faces 242 and 243.

Referring to FIG. 29, positioning the retaining bodies 234 and 235 over the mating member 240 such that the retaining bodies 234 and 235 contact at least partially the faces 242 and 243 of the mating member 240 respectively, and such that the mating member 240 is at least partially positioned within the space 237 of the retainer 233, couples the retainer 233 to the mating member 240, and therefore also couples the furniture accessory 232 to the furniture apparatus 231. In some embodiments, the mating member 240 has a length 245 that is longer than a length 246 of the retainer 233. By virtue of the mating member 240 being longer than the retainer 233, the retainer 233 (and therefore the furniture accessory 232) may be coupled to the mating member 240 along any portion of the mating member 240, which may in some embodiments facilitate placement of the furniture accessory 232 relative to the furniture apparatus 231 at a desired location along the mating member 240.

The retaining bodies 234 and 235 may include electrical contacts 251 and 252 respectively. The electrical contacts 251 and 252 may, for example, extend laterally across the retaining bodies 234 and 235. The mating member 240 may include electrical contacts 253 and 254 as shown in FIG. 27. Electrical contacts 253 and 254 may, for example, extend laterally across faces 242 and 243 respectively. The electrical contacts 251 and 252 may be electrical contacts of the furniture accessory 232. The electrical contacts 253 and 254 may be electrical contacts of the furniture apparatus 231. In some embodiments, any one, more than one, or all of electrical contacts 251, 252, 253, and 254 is or includes a continuous strip of electrically conductive material.

The electrical contacts 251, 252, 253, and 254 may be positioned such that, when retainer 233 is positioned over and receives the respective portion of the mating member 240 (and the retaining body 234 contacts face 242, and the retaining body 235 contacts face 243), the electrical contacts 251 and 253 contact each other and become electrically coupled, and the electrical contacts 252 and 254 contact each other and become electrically coupled thereby electrically coupling the furniture accessory 232 with the furniture apparatus 231. Electrically coupling the furniture accessory 232 with the furniture apparatus 231 may allow an electrical load on the furniture accessory 232 to receive electric voltage and electric current from a source of electrical power of the furniture apparatus 231 or vice versa.

The furniture accessory 232 may include an electrical load. An electrical load on the furniture accessory 232 may be electrically coupled to the electrical contacts on the retainer 233, to allow the electrical load to receive electric voltage and electric current from such one or more electrical contacts.

For example, as shown in FIG. 29, the furniture accessory 232 includes an electric light source 260. Like the electric light source 175 described above, the electric light source 260 may include one or more LEDs, one or more incandescent light bulbs, one or more halogen light bulbs, one or more other electric light sources, or a combination of two or more thereof, and the electric light source 260 is an example of an electrical load on the furniture accessory 232. The electric light source 260 may, in operation, transmit light through an exterior surface of the furniture accessory 232. The exterior surface of the furniture accessory 232 may be partly or entirely translucent or transparent.

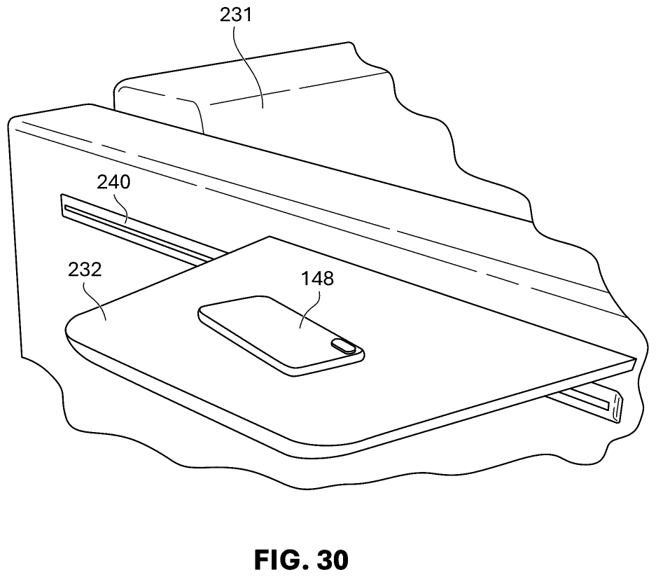

Additionally, or alternatively, the furniture accessory 232, as shown in FIG. 30, may include an electric battery charger, which may be configured to charge a device (the mobile device 148 in the embodiment shown), and which may be configured to charge such a device wirelessly.

In this embodiment, an elongate body described herein, such as the mating member 240 for example, may be coupled to a surface. The elongate body and the surface may define a space. At least a portion of a retainer, such as the retainer 233 for example, may be positioned within the space. When the retainer is at least partially positioned within the space, the retainer may have a first contact region (or contact point) on, for example, the retaining body 234 contactingly engageable with the elongate body within the space and a second contact region (or point) on, for example, the retaining body 235 engageable to at least partially prevent rotation of the retainer about the elongate body induced by a force in a direction that urges the retainer into the space. The force may, for example, include gravitational force exerted on furniture accessory 232, downward forces on furniture accessory 232 exerted by a user, etc.

The first and second contact regions may be on different portions of the retainer such as on the retaining bodies 234 and 235 as described above or on the same portion of the retainer such as, for example, on a single retaining body.

In some embodiments, the elongate body is removably coupled to the surface. The surface may, for example, be a surface of a furniture apparatus such as the outward face 244 of the armrest body 241. In some embodiments, the surface is integrally coupled to the elongate body. In some such embodiments, the surface and the elongate body may be coupled to a furniture apparatus. In some embodiments, the elongate body is coupled to a furniture accessory and the retainer is coupled to a furniture apparatus.

A retainer described herein may be an element that is separate from and couplable to a furniture apparatus or furniture accessory. However, in some embodiments, a retainer described herein is an element that is integrally formed or integrally coupled to a furniture apparatus or furniture accessory. A retainer described herein may include a one-piece element or an element comprising a plurality of pieces.

The embodiments as described herein are examples only, and alternative embodiments may differ. In general, elements of embodiments as described herein may be interchangeably used in other embodiments described herein. For example, in embodiments as described herein, retainers may replace elongate bodies and elongate bodies may replace retainers. Also, an electrical load of one embodiment may replace an electrical load of another embodiment. In general, elements of the embodiments as described herein may be varied, repositioned, reoriented, substituted, exchanged, combined, separated, omitted, or two or more thereof. Also, alternative embodiments may include more, fewer, or different elements that may be in different positions, in different orientations, or both, and alternative embodiments may include different shapes.

Further in some embodiments, support bodies, elongate bodies, retainers, or any two or more thereof, as described herein, may be concealed within or behind upholstery.

In general, embodiments such as those described herein may facilitate electrical coupling a furniture accessory to a furniture apparatus, for example by electrically coupling one or more electrical loads to one or more sources of electrical power conveniently (for example, without tools and without additional steps) and with fewer exposed or visible electrical wires when compared to other methods.

Although specific embodiments have been described and illustrated, such embodiments should be considered illustrative only and not as limiting the invention.

This disclosure also further includes, but is not limited to, the following examples, each of which may be an example of one or more embodiments described or illustrated herein, and each of which may be combined with one or more other examples, embodiments, or any other subject matter described or illustrated herein.
1. A method of coupling a furniture accessory to a furniture apparatus, the method comprising:
   positioning a portion of an elongate body, coupled to the furniture accessory, in a space between at least two retaining bodies of a retainer coupled to the furniture apparatus such that the at least two retaining bodies contact an exterior surface of the elongate body on at least the portion of the elongate body and retain at least the portion of the elongate body in the space.
2. The method of example 1, wherein positioning the portion of the elongate body in the space comprises rotating the elongate body and the furniture accessory towards the furniture apparatus.
3. The method of example 2, wherein rotating the elongate body and the furniture accessory towards the furniture apparatus comprises rotating the elongate body and the furniture accessory around a portion of a second elongate body in a space between at least two retaining bodies of a second retainer coupled to the furniture apparatus.
4. The method of example 1, 2, or 3, wherein positioning the portion of the elongate body in the space comprises electrically coupling at least one electrical contact of the furniture accessory with at least one electrical contact of the furniture apparatus.
5. A method of electrically coupling at least one electrical contact on a furniture accessory to at least one electrical contact on a furniture apparatus, the method comprising:
   positioning a portion of an elongate body, coupled to the furniture apparatus, in a space between at least two retaining bodies of a retainer coupled to the furniture accessory such that the at least two retaining bodies contact an exterior surface of the elongate body on at least the portion of the elongate body and retain at least the portion of the elongate body in the space;
   wherein positioning the portion of the elongate body in the space comprises electrically coupling at least one electrical contact of the furniture accessory with at least one electrical contact of the furniture apparatus.
6. The method of example 4, wherein the at least one electrical contact of the furniture accessory comprises at least one electrical contact on the elongate body.
7. The method of example 5, wherein the at least one electrical contact of the furniture apparatus comprises at least one electrical contact on the elongate body.
8. The method of example 6 or 7, wherein the at least one electrical contact on the elongate body is on the exterior surface of the elongate body.
9. The method of example 8, wherein the at least one electrical contact on the elongate body is flush with the exterior surface of the elongate body.
10. The method of example 8, wherein the at least one electrical contact on the elongate body comprises at least one protrusion from the exterior surface of the elongate body.
11. The method of example 8 or 10, wherein the at least one electrical contact on the elongate body comprises at least one electrical contact recessed behind the exterior surface of the elongate body.
12. The method of any one of examples 6 to 11, wherein the at least one electrical contact on the elongate body is electrically coupled with at least one elongate-body electrical conductor, and at least a portion of the at least one elongate-body electrical conductor is enclosed in the elongate body.
13. The method of example 4 or 6, or of any one of examples 8 to 12 when dependent from example 4, wherein the at least one electrical contact of the furniture apparatus comprises at least one electrical contact on the retainer.
14. The method of example 13, wherein the at least one electrical contact on the retainer is electrically coupled with at least one furniture-apparatus electrical conductor, and at least a portion of the at least one furniture-apparatus electrical conductor is enclosed in the furniture apparatus.
15. The method of example 5 or 7, or of any one of examples 8 to 12 when dependent from example 5, wherein the at least one electrical contact of the furniture accessory comprises at least one electrical contact on the retainer.
16. The method of example 13, 14, or 15, wherein the at least one electrical contact on the retainer faces into the space.
17. The method of example 13, 14, 15, or 16, wherein the at least one electrical contact on the retainer is between the at least two retaining bodies.
18. The method of any one of examples 13 to 17, wherein the at least one electrical contact on the retainer comprises at least one protrusion into the space.
19. The method of any one of examples 13 to 18, wherein the at least one electrical contact on the retainer comprises at least one electrical contact recessed behind a surface defining at least a portion of the space.
20. The method of any one of examples 4 to 19, wherein electrically coupling the at least one electrical contact of the furniture accessory with the at least one electrical contact of the furniture apparatus comprises electrically coupling at least one source of electric current of the furniture apparatus with at least one electrical load on the furniture accessory.
21. The method of example 20, wherein at least a portion of the at least one source of electric current of the furniture apparatus is enclosed in the furniture apparatus.
22. The method of example 20 or 21, wherein at least a portion of the at least one source of electric current of the furniture apparatus is on the furniture apparatus.
23. The method of example 20, 21, or 22, wherein at least a portion of the at least one source of electric current of the furniture apparatus is coupled to the furniture apparatus.
24. The method of example 20, 21, 22, or 23, wherein the at least one source of electric current comprises at least one source of electrical control signals of the furniture apparatus.
25. The method of any one of examples 20 to 24, wherein the at least one source of electric current comprises at least one source of electrical power of the furniture apparatus.
26. The method of any one of examples 4 to 19, wherein electrically coupling the at least one electrical contact of the furniture accessory with the at least one electrical contact of the furniture apparatus comprises electrically coupling at least one source of electrical power of the furniture accessory with at least one electrical load on the furniture apparatus.
27. The method of example 26, wherein the at least one source of electrical power of the furniture accessory comprises an electric battery.
28. The method of example 25, 26, or 27, wherein the at least one source of electrical power is configured to, at least:
   detect electrical coupling of the at least one source of electrical power to at least one authorized electrical load; and
   provide electrical power to the at least one authorized electrical load in response to detecting the at least one authorized electrical load.
29. The method of any one of examples 20 to 28, wherein the at least one electrical load comprises an electric motor.
30. The method of example 29, wherein the electric motor is operable to move at least a portion of the furniture accessory relative to the furniture apparatus.
31. The method of any one of examples 20 to 30, wherein the at least one electrical load comprises an electric light source.
32. The method of example 31, wherein at least a portion of the electric light source is enclosed in the elongate body and operable to transmit light through the exterior surface of the elongate body.
33. The method of any one of examples 20 to 32, wherein the at least one electrical load comprises an electric battery charger.
34. The method of example 33, wherein the electric battery charger is configured to charge a mobile device.
35. The method of example 33, wherein the electric battery charger is configured to charge a device wirelessly.
36. The method of any one of examples 1 to 35, wherein:
   the elongate body is at least a portion of a rod; and
   the exterior surface of the elongate body is generally cylindrical.
37. The method of any one of examples 1 to 36, wherein positioning the portion of the elongate body in the space comprises:
   causing at least one of the at least two retaining bodies to move resiliently to increase a separation distance between the at least two retaining bodies to allow the space to receive the portion of the elongate body; and
   after the space receives the portion of the elongate body, causing the at least one of the at least two retaining bodies to move resiliently to decrease the separation distance between the at least two retaining bodies to retain the portion of the elongate body in the space.
38. The method of example 5, wherein the at least one electrical contact of the furniture accessory comprises at least one electrical contact on a first one of the at least two retaining bodies, and at least one electrical contact on a second one of the at least two retaining bodies.
39. The method of example 38, wherein each of the at least one electrical contact on the first one of the at least two retaining bodies and the at least one electrical contact on the second one of the at least two retaining bodies comprises an electrically conductive strip.
40. The method of example 38 or 39, wherein the first one of the at least two retaining bodies is at an offset angle to the second one of the at least two retaining bodies.
41. The method of example 40, wherein the exterior surface of the elongate body comprises a first face and a second face, the first face at the offset angle to the second face.
42. The method of example 41, wherein each of the first and second faces of the elongate body comprises an electrically conductive strip.
43. The method of example 41 or 42, wherein positioning the portion of the elongate body in the space between the at least two retaining bodies of the retainer comprises causing the first one of the at least two retaining bodies to contact the first face of the elongate body, and causing the second one of the at least two retaining bodies to contact the second face of the elongate body.
44. The method of example 43, wherein causing the first one of the at least two retaining bodies to contact the first face of the elongate body electrically couples the first one of the at least two retaining bodies to the first face of the elongate body, and causing the second one of the at least two retaining bodies to contact the second face of the elongate body electrically couples the second one of the at least two retaining bodies to the second face of the elongate body.
45. The method of any one of examples 38 to 44, wherein the first one of the at least two retaining bodies is shorter than the second one of the at least two retaining bodies.
46. The method of any one of examples 5 or 38 to 45, wherein the retainer comprises a French cleat.
47. The method of any one of examples 5 or 38 to 46, wherein the elongate body comprises a mating cleat.
48. The method of any one of examples 1 to 47, wherein the furniture apparatus comprises an upholstered bed.
49. The method of any one of examples 1 to 47, wherein the furniture apparatus comprises a seating apparatus.
50. The method of any one of examples 1 to 47, wherein the furniture apparatus is a seating apparatus consisting of at least one body configured to facilitate seating on the seating apparatus.
51. The method of any one of examples 1 to 47, wherein the furniture apparatus is a seating apparatus consisting essentially of at least one body configured to facilitate seating on the seating apparatus.
52. The method of example 49, 50, or 51, wherein the seating apparatus is a chair.
53. The method of example 49, 50, 51, or 52, wherein the furniture accessory is a second chair.
54. The method of any one of examples 1 to 52, wherein the furniture accessory is a headrest.
55. The method of any one of examples 1 to 52, wherein the furniture accessory is a table.
56. The method of any one of examples 1 to 52, wherein the furniture accessory is a tray.
57. The method of any one of examples 1 to 56, wherein positioning the portion of the elongate body in the space comprises mounting the furniture accessory on the furniture apparatus.
58. The method of any one of examples 1 to 56, wherein positioning the portion of the elongate body in the space comprises coupling the furniture accessory directly to the furniture apparatus.
59. The method of any one of examples 1 to 58, wherein the furniture apparatus is independent of any vehicle.
60. A furniture system comprising:
   a furniture accessory;
   an elongate body coupled to the furniture accessory;
   a furniture apparatus; and
   a retainer coupled to the furniture apparatus, the retainer comprising two retaining bodies and defining a space between at least the two retaining bodies;
   wherein a portion of the elongate body is positionable in the space such that, when the portion of the elongate body is positioned in the space, the at least two retaining bodies contact an exterior surface of the elongate body on at least the portion of the elongate body and retain at least the portion of the elongate body in the space.
61. The system of example 60, further comprising:
   a second elongate body coupled to the furniture accessory; and
   a second retainer coupled to the furniture apparatus, the second retainer comprising two retaining bodies and defining a space between at least the two retaining bodies of the second retainer;
   wherein when a portion of the second elongate body is in the space between the at least two retaining bodies of the second retainer, the elongate body and the furniture accessory are rotatable, around the portion of the second elongate body, such that the portion of the elongate body is positionable in the space of the retainer in response to rotation of the elongate body and the furniture accessory towards the furniture apparatus and around the portion of the second elongate body.
62. The system of example 60 or 61, wherein:
   the furniture accessory comprises at least one electrical contact;
   the furniture apparatus comprises at least one electrical contact; and
   the at least one electrical contact of the furniture accessory and the at least one electrical contact of the furniture apparatus are positioned such that the at least one electrical contact of the furniture accessory is electrically couplable with the at least one electrical contact of the furniture apparatus in response to positioning the portion of the elongate body in the space.
63. A furniture system comprising:
   a furniture accessory;
   a retainer coupled to the furniture accessory, the retainer comprising two retaining bodies and defining a space between at least the two retaining bodies;
   a furniture apparatus; and
   an elongate body coupled to the furniture apparatus;
   wherein:
      a portion of the elongate body is positionable in the space such that, when the portion of the elongate body is positioned in the space, the at least two retaining bodies contact an exterior surface of the elongate body on at least the portion of the elongate body and retain at least the portion of the elongate body in the space;
      the furniture accessory comprises at least one electrical contact;
      the furniture apparatus comprises at least one electrical contact; and
      the at least one electrical contact of the furniture accessory and the at least one electrical contact of the furniture apparatus are positioned such that the at least one electrical contact of the furniture accessory is electrically couplable with the at least one electrical contact of the furniture apparatus in response to positioning the portion of the elongate body in the space.
64. The system of example 62, wherein the at least one electrical contact of the furniture accessory comprises at least one electrical contact on the elongate body.
65. The system of example 63, wherein the at least one electrical contact of the furniture apparatus comprises at least one electrical contact on the elongate body.
66. The system of example 64 or 65, wherein the at least one electrical contact on the elongate body is on the exterior surface of the elongate body.
67. The system of example 62 or 64, or of example 66 when dependent from example 54, wherein the at least one electrical contact of the furniture apparatus comprises at least one electrical contact on the retainer.
68. The system of example 67, wherein the at least one electrical contact on the retainer is electrically coupled with at least one furniture-apparatus electrical conductor, and at least a portion of the at least one furniture-apparatus electrical conductor is enclosed in the furniture apparatus.
69. The system of example 63 or 65, or of example 66 when dependent from example 65, wherein the at least one electrical contact of the furniture accessory comprises at least one electrical contact on the retainer.
70. The system of example 67, 68, or 69, wherein the at least one electrical contact on the retainer faces into the space.
71. A furniture system comprising:
   a furniture accessory; and
   an elongate body coupled to the furniture accessory, wherein at least one electrical contact of the furniture accessory is on an exterior surface of the elongate body.
72. A furniture system comprising:
   a furniture apparatus; and
   an elongate body coupled to the furniture apparatus, wherein at least one electrical contact of the furniture apparatus is on an exterior surface of the elongate body.
73. A furniture system comprising:
   a furniture accessory; and
   a retainer coupled to the furniture accessory, the retainer comprising two retaining bodies and defining a space between at least the two retaining bodies, wherein at least one electrical contact of the furniture accessory is on the retainer and faces into the space.
74. A furniture system comprising:
   a furniture apparatus; and
   a retainer coupled to the furniture apparatus, the retainer comprising two retaining bodies and defining a space between at least the two retaining bodies, wherein at least one electrical contact of the furniture apparatus is on the retainer and faces into the space.
75. The system of example 64, 65, or 66, or of any one of examples 67 to 70 when directly or indirectly dependent from example 64 or 65, or of example 71 or 72, wherein the at least one electrical contact on the elongate body is flush with the exterior surface of the elongate body.
76. The system of example 64, 65, or 66, or of any one of examples 67 to 70 when directly or indirectly dependent from example 64 or 65, or of example 71 or 72, wherein the at least one electrical contact on the elongate body comprises at least one protrusion from the exterior surface of the elongate body.
77. The system of example 64, 65, or 66, or of any one of examples 67 to 70 when directly or indirectly dependent from example 64 or 65, or of example 71 or 72, wherein the at least one electrical contact on the elongate body comprises at least one electrical contact recessed behind the exterior surface of the elongate body.
78. The system of example 64, 65, or 66, or of any one of examples 67 to 70 when directly or indirectly dependent from example 64 or 65, or of any one of examples 71 to 77, wherein the at least one electrical contact on the elongate body is electrically coupled with at least one elongate-body electrical conductor, and at least a portion of the at least one elongate-body electrical conductor is enclosed in the elongate body.
79. The system of example 67, 68, 69, 70, 73, or 74, or of any one of examples 75 to 78 when directly or indirectly dependent from example 67, 69, 73, or 74, wherein the at least one electrical contact on the retainer is between the at least two retaining bodies.
80. The system of example 67, 68, 69, 70, 73, 74, or 79, or of any one of examples 75 to 78 when directly or indirectly dependent from example 67, 69, 73, or 74, wherein the at least one electrical contact on the retainer comprises at least one protrusion into the space.
81. The system of example 67, 68, 69, 70, 73, 74, 79, or 80, or of any one of examples 75 to 78 when directly or indirectly dependent from example 67, 69, 73, or 74, wherein the at least one electrical contact on the retainer comprises at least one electrical contact recessed behind a surface defining at least a portion of the space.
82. The system of any one of examples 62 to 70, or of example 72 or 74, or of any one of examples 75 to 80 when directly or indirectly dependent from example 62, 63, 72, or 74, wherein:
   the furniture apparatus comprises at least one source of electric current; and
   the at least one source of electric current of the furniture apparatus is electrically coupled with the at least one electrical contact of the furniture apparatus.
83. The system of example 82, wherein at least a portion of the at least one source of electric current of the furniture apparatus is enclosed in the furniture apparatus.
84. The system of example 82 or 83, wherein at least a portion of the at least one source of electric current of the furniture apparatus is on the furniture apparatus.
85. The system of example 82, 83, or 84, wherein at least a portion of the at least one source of electric current of the furniture apparatus is coupled to the furniture apparatus.
86. The system of example 82, 83, 84, or 85, wherein the at least one source of electric current comprises at least one source of electrical control signals of the furniture apparatus.
87. The system of any one of examples 82 to 86, wherein the at least one source of electric current comprises at least one source of electrical power of the furniture apparatus.
88. The system of any one of examples 62 to 70, or of example 71 or 73, or of any one of examples 75 to 80 when directly or indirectly dependent from example 62, 63, 71, or 73, wherein:
   the furniture accessory comprises at least one source of electric power; and
   the at least one source of electric power of the furniture accessory is electrically coupled with the at least one electrical contact of the furniture accessory.
89. The system of example 88, wherein the at least one source of electrical power of the furniture accessory comprises an electric battery.
90. The system of example 87, 88, or 89, wherein the at least one source of electrical power is configured to, at least:
   detect electrical coupling of the at least one source of electrical power to at least one authorized electrical load; and
   provide electrical power to the at least one authorized electrical load in response to detecting the at least one authorized electrical load.
91. The system of any one of examples 62 to 70, or of example 72 or 74, of any one of examples 75 to 81 or 88 to 90 when directly or indirectly dependent from example 62, 63, 72, or 74, wherein at least one electrical load is on the furniture apparatus.
92. The system of any one of examples 62 to 70, or of example 71 or 73, of any one of examples 75 to 87 when directly or indirectly dependent from example 62, 63, 71, or 73, wherein at least one electrical load is on the furniture accessory.
93. The system of example 91 or 92, wherein the at least one electrical load comprises an electric motor.
94. The system of example 93, wherein the electric motor is operable to move at least a portion of the furniture accessory relative to the furniture apparatus.
95. The system of example 91, 92, 93, or 94, wherein the at least one electrical load comprises an electric light source.
96. The system of example 95, wherein at least a portion of the electric light source is enclosed in the elongate body and operable to transmit light through the exterior surface of the elongate body.
97. The system of any one of examples 91 to 96, wherein the at least one electrical load comprises an electric battery charger.
98. The system of example 97, wherein the electric battery charger is configured to charge a mobile device.
99. The system of example 97, wherein the electric battery charger is configured to charge a device wirelessly.
100. The system of any one of examples 60 to 72, or of any one of examples 75 to 99 when directly or indirectly dependent from example 60, 63, 71, or 72, wherein:
   the elongate body is at least a portion of a rod; and
   the exterior surface of the elongate body is generally cylindrical.
101. The system of any one of examples 60 to 70, of example 73 or 74, or of any one of examples 75 to 100 when directly or indirectly dependent from example 60, 63, 73, or 74, wherein at least one of the at least two retaining bodies is resiliently movable to increase a separation distance between the at least two retaining bodies.
102. The system of example 101 when directly or indirectly dependent from example 60, 63, 71, or 72, wherein the at least two retaining bodies are positioned such that:
   the at least one of the at least two retaining bodies moves resiliently to increase the separation to allow the space to receive the portion of the elongate body; and
   after the space receives the portion of the elongate body, the at least one of the at least two retaining bodies moves resiliently to decrease the separation distance between the at least two retaining bodies to retain the portion of the elongate body in the space.
103. The system of any one of examples 60 to 70, or of example 72 or 74, or of any one of examples 75 to 102 when directly or indirectly dependent from example 60, 63, 72, or 74, wherein the furniture apparatus comprises an upholstered bed.
104. The system of any one of examples 60 to 70, or of example 72 or 74, or of any one of examples 75 to 102 when directly or indirectly dependent from example 60, 63, 72, or 74, wherein the furniture apparatus comprises a seating apparatus.
105. The system of any one of examples 60 to 70, or of example 72 or 74, or of any one of examples 75 to 102 when directly or indirectly dependent from example 60, 63, 72, or 74, wherein the furniture apparatus is a seating apparatus consisting of at least one body configured to facilitate seating on the seating apparatus.
106. The system of any one of examples 60 to 70, or of example 72 or 74, or of any one of examples 75 to 102 when directly or indirectly dependent from example 60, 63, 72, or 74, wherein the furniture apparatus is a seating apparatus consisting essentially of at least one body configured to facilitate seating on the seating apparatus.
107. The system of example 104, 105, or 106, wherein the furniture accessory is a second chair.
108. The system of any one of examples 60 to 71, or of example 73, or of any one of examples 75 to 106 when directly or indirectly dependent from example 60, 63, 71, or 73, wherein the furniture accessory is a headrest.
109. The system of any one of examples 60 to 71, or of example 73, or of any one of examples 75 to 106 when directly or indirectly dependent from example 60, 63, 71, or 73, wherein the furniture accessory is a table.
110. The system of any one of examples 60 to 71, or of example 73, or of any one of examples 75 to 106 when directly or indirectly dependent from example 60, 63, 71, or 73, wherein the furniture accessory is a tray.
111. The system of any one of examples 60 to 70, or of example 72 or 74, or of any one of examples 75 to 110 when directly or indirectly dependent from example 60, 63, 72, or 74, wherein the furniture apparatus is independent of any vehicle.
112. The system of example 62 when dependent from example 60, or example 63 or 73, wherein the least one electrical contact of the furniture accessory comprises at least one electrical contact on a first one of the at least two retaining bodies, and at least one electrical contact on a second one of the at least two retaining bodies.
113. The system of example 112, wherein each of the at least one electrical contact on the first one of the at least two retaining bodies and the at least one electrical contact on the second one of the at least two retaining bodies comprises an electrically conductive strip.
114. The system of example 112 or 113, wherein the first one of the at least two retaining bodies is at an offset angle to the second one of the at least two retaining bodies.
115. The system of example 114, wherein the exterior surface of the elongate body comprises a first face and a second face, the first face at the offset angle to the second face.
116. The system of example 115, wherein each of the first and second faces of the elongate body comprises an electrically conductive strip.
117. The system of example 115 or 116, wherein the first one of the at least two retaining bodies contacts the first face of the elongate body, and the second one of the at least two retaining bodies contacts the second face of the elongate body.
118. The system of example 117, wherein the first one of the at least two retaining bodies contacting the first face of the elongate body electrically couples the first one of the at least two retaining bodies to the first face of the elongate body, and the second one of the at least two retaining bodies contacting the second face of the elongate body electrically couples the second one of the at least two retaining bodies to the second face of the elongate body.
119. The system of any one of examples 63 or 112 to 118, wherein the first one of the at least two retaining bodies is shorter than the second one of the at least two retaining bodies.
120. The system of any one of examples 63 or 112 to 119, wherein the retainer comprises a French cleat.
121. The system of any one of examples 63 or 112 to 120, wherein the elongate body comprises a mating cleat.
122. A furniture system comprising:
   an elongate body coupled to a surface, the elongate body and the surface defining a space; and
   a retainer, the retainer at least partially positionable within the space to couple the retainer to the elongate body, such that when the retainer is at least partially positioned within the space the retainer has a first contact region contactingly engageable with the elongate body within the space and a second contact region engageable to at least partially prevent rotation of the retainer about the elongate body induced by a force in a direction that urges the retainer into the space.
123. The system of example 122, wherein the elongate body is coupled to a furniture apparatus.
124. The system of example 122 or 123, wherein the retainer is coupled to a furniture accessory.
125. The system of example 122, wherein the elongate body is coupled to a furniture accessory.
126. The system of example 122 or 125, wherein the retainer is coupled to a furniture apparatus.
127. The system of any one of examples 122 to 126, wherein the elongate body comprises at least one electrical contact and the retainer comprises at least one electrical contact, and wherein when the retainer is at least partially positioned in the space the at least one electrical contact of the retainer is electrically coupled to the at least one electrical contact of the elongate body.
128. The system of any one of examples 122 to 127, wherein the retainer has a length that is shorter than a length of the elongate body.
129. The system of any one of examples 122 to 128, wherein the retainer comprises a French cleat.
130. The system of any one of examples 122 to 129, wherein the elongate body comprises a mating cleat.
131. The system of any one of examples 122 to 130, wherein the elongate body and the surface are removably coupled together.
132. The system of any one of examples 122 to 131, wherein the elongate body and the surface are integrally coupled together.
133. A method of coupling a furniture accessory to a furniture apparatus, the method comprising:
   positioning at least partially a retainer within a space between an elongate body and a surface to which the elongate body is coupled, wherein at least partially positioning the retainer within the space contactingly engages a first contact region of the retainer with the elongate body within the space and engages a second contact region of the retainer to at least partially prevent rotation of the retainer about the elongate body induced by a force in a direction that urges the retainer into the space.
134. The method of example 133, wherein the elongate body is coupled to the furniture apparatus.
135. The method of example 133 or 134, wherein the retainer is coupled to the furniture accessory.
136. The method of example 133, wherein the elongate body is coupled to the furniture accessory.
137. The method of example 133 or 136, wherein the retainer is coupled to the furniture apparatus.
138. The method of any one of examples 133 to 137, wherein at least partially positioning the retainer in the space causes the retainer to be electrically coupled to the elongate body.
139. The method of any one of examples 133 to 138, wherein the retainer has a length that is shorter than a length of the elongate body.
140. The method of any one of examples 133 to 139, wherein the retainer comprises a French cleat.
141. The method of any one of examples 133 to 140, wherein the elongate body comprises a mating cleat.
142. The method of any one of examples 133 to 141, wherein the elongate body and the surface are removably coupled together.
143. The method of any one of examples 133 to 141, wherein the elongate body and the surface are integrally coupled together.

1. A method of electrically coupling at least one electrical contact on a furniture accessory to at least one electrical contact on a furniture apparatus, the method comprising:
positioning a portion of an elongate body, coupled to the furniture apparatus, in a space between at least two retaining bodies of a retainer coupled to the furniture accessory such that the at least two retaining bodies contact an exterior surface of the elongate body on at least the portion of the elongate body and retain at least the portion of the elongate body in the space;
wherein positioning the portion of the elongate body in the space comprises electrically coupling at least one electrical contact of the furniture accessory with at least one electrical contact of the furniture apparatus.

2. The method of claim 1, wherein electrically coupling the at least one electrical contact of the furniture accessory with the at least one electrical contact of the furniture apparatus comprises electrically coupling at least one source of electric current of the furniture apparatus with at least one electrical load on the furniture accessory.

3. The method of claim 2, wherein the at least one source of electric current comprises at least one source of electrical power of the furniture apparatus.

4. The method of claim 3, wherein the at least one source of electrical power is configured to, at least:
detect electrical coupling of the at least one source of electrical power to at least one authorized electrical load; and
provide electrical power to the at least one authorized electrical load in response to detecting the at least one authorized electrical load.

5. The method of claim 1, wherein electrically coupling the at least one electrical contact of the furniture accessory with the at least one electrical contact of the furniture apparatus comprises electrically coupling at least one source of electrical power of the furniture accessory with at least one electrical load on the furniture apparatus.

6. The method of claim 5, wherein the at least one source of electrical power is configured to, at least:
detect electrical coupling of the at least one source of electrical power to at least one authorized electrical load; and
provide electrical power to the at least one authorized electrical load in response to detecting the at least one authorized electrical load.

7. The method of claim 1, wherein positioning the portion of the elongate body in the space comprises:
causing at least one of the at least two retaining bodies to move resiliently to increase a separation distance between the at least two retaining bodies to allow the space to receive the portion of the elongate body; and
after the space receives the portion of the elongate body, causing the at least one of the at least two retaining bodies to move resiliently to decrease the separation distance between the at least two retaining bodies to retain the portion of the elongate body in the space.

8. The method of claim 1, wherein the at least one electrical contact of the furniture accessory comprises at least one electrical contact on a first one of the at least two retaining bodies, and at least one electrical contact on a second one of the at least two retaining bodies.

9. The method of claim 8, wherein positioning the portion of the elongate body in the space between the at least two retaining bodies of the retainer comprises causing the first one of the at least two retaining bodies to contact a first face of the elongate body, and causing the second one of the at least two retaining bodies to contact a second face of the elongate body.

10. The method of claim 1, wherein the retainer comprises a French cleat.

11. The method of claim 1, wherein positioning the portion of the elongate body in the space comprises mounting the furniture accessory on the furniture apparatus.

12. The method of claim 1, wherein positioning the portion of the elongate body in the space comprises coupling the furniture accessory directly to the furniture apparatus.

13. A method of coupling a furniture accessory to a furniture apparatus, the method comprising:
positioning a portion of an elongate body, coupled to the furniture accessory, in a space between at least two retaining bodies of a retainer coupled to the furniture apparatus such that the at least two retaining bodies contact an exterior surface of the elongate body on at least the portion of the elongate body and retain at least the portion of the elongate body in the space.

14. The method of claim 13, wherein positioning the portion of the elongate body in the space comprises rotating the elongate body and the furniture accessory towards the furniture apparatus.

15. The method of claim 14, wherein rotating the elongate body and the furniture accessory towards the furniture apparatus comprises rotating the elongate body and the furniture accessory around a portion of a second elongate body in a space between at least two retaining bodies of a second retainer coupled to the furniture apparatus.

16. The method of claim 13, wherein positioning the portion of the elongate body in the space comprises electrically coupling at least one electrical contact of the furniture accessory with at least one electrical contact of the furniture apparatus.

17. The method of claim 16, wherein electrically coupling the at least one electrical contact of the furniture accessory with the at least one electrical contact of the furniture apparatus comprises electrically coupling at least one source of electric current of the furniture apparatus with at least one electrical load on the furniture accessory.

18. The method of claim 17, wherein the at least one source of electric current comprises at least one source of electrical power of the furniture apparatus.

19. The method of claim 16, wherein electrically coupling the at least one electrical contact of the furniture accessory with the at least one electrical contact of the furniture apparatus comprises electrically coupling at least one source of electrical power of the furniture accessory with at least one electrical load on the furniture apparatus.

20. The method of claim 13, wherein positioning the portion of the elongate body in the space comprises:
causing at least one of the at least two retaining bodies to move resiliently to increase a separation distance between the at least two retaining bodies to allow the space to receive the portion of the elongate body; and
after the space receives the portion of the elongate body, causing the at least one of the at least two retaining bodies to move resiliently to decrease the separation distance between the at least two retaining bodies to retain the portion of the elongate body in the space.
